(19) United States
(12) Patent Application Publication
(10) Pub. No.: US 2016/0274923 A1
(43) Pub. Date: Sep. 22, 2016

(54) AN APPARATUS, METHOD, AND SYSTEM FOR A FAST CONFIGURATION MECHANISM

(71) Applicant: INTEL CORPORATION, Santa Clara, CA (US)

(72) Inventor: David HARRIMAN, Portland, OR (US)

(73) Assignee: INTEL CORPORATION, Santa Clara, CA (US)

(21) Appl. No.: 14/410,468

(22) PCT Filed: Jan. 16, 2014
(86) PCT No.: PCT/US2014/011899

§ 371 Date: Jan. 5, 2015

(51) Int. Cl. G06F 9/445; G06F 13/42

(52) U.S. Cl. CPC G06F 9/44505; G06F 13/4282; G06F 13/4208

(57) ABSTRACT

An apparatus, method, and system is described herein for fast device configuration. Fast configuration devices may be configured without host intervention. For example, before going into a low power mode, the device may dump its configuration context to storage and go to sleep. Then, upon resuming into an active state, a controller can reload the context without a host processing device having to re-write the entire configuration space, which potentially reduces the latency decision of when a device goes into a low power mode. Moreover, fast configuration mechanism may accelerate configuration accesses from the host by providing accelerated completions, while still ensuring legacy configuration for legacy devices.

### FIELD

This disclosure pertains to computing system, and in particular (but not exclusively) to configuration of devices for an interconnect architecture.

### BRIEF DESCRIPTION OF THE DRAWINGS

FIG. 1 illustrates an embodiment of a block diagram for a computing system including a multicore processor.

FIG. 2 illustrates an embodiment of a computing system including an a peripheral component interconnect express (PCIe) compliant architecture.

FIG. 3 illustrates an embodiment of a PCIe compliant interconnect architecture including a layered stack.

FIG. 4 illustrates an embodiment of a PCIe compliant request or packet to be generated or received within an interconnect architecture.

FIG. 5 illustrates an embodiment of a transmitter and receiver pair for a PCIe compliant interconnect architecture.

FIG. 6 illustrates embodiments of a logical view for a memory mapped configuration space.

FIG. 7 illustrates an embodiment of a controller to configure elements of an interconnect architecture.

FIG. 8 illustrates an embodiment of a protocol diagram for configuring an element using memory accesses from a host device.

FIG. 9 illustrates an embodiment of configuration logic for fast device configuration.

FIG. 10 illustrates an embodiment of a protocol diagram for fast configuration of an element.

FIG. 11 illustrates an embodiment of a protocol diagram for a device to indicate fast configuration capability.

FIG. 12 illustrates an embodiment of a configuration space for an element in an interconnect architecture.

FIG. 13 illustrates an embodiment of a flow diagram for a method of configuring a device.

FIG. 14 illustrates an embodiment of a low power computing platform.

FIG. 15 illustrates an embodiment of a processor including an on-die interconnect.

FIG. 16 illustrates an embodiment of a computing system on a chip.

FIG. 17 illustrates an embodiment of a block diagram for a computing system.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific configuration parameters, etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to server, desktop, or lightweight computing devices, such as Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

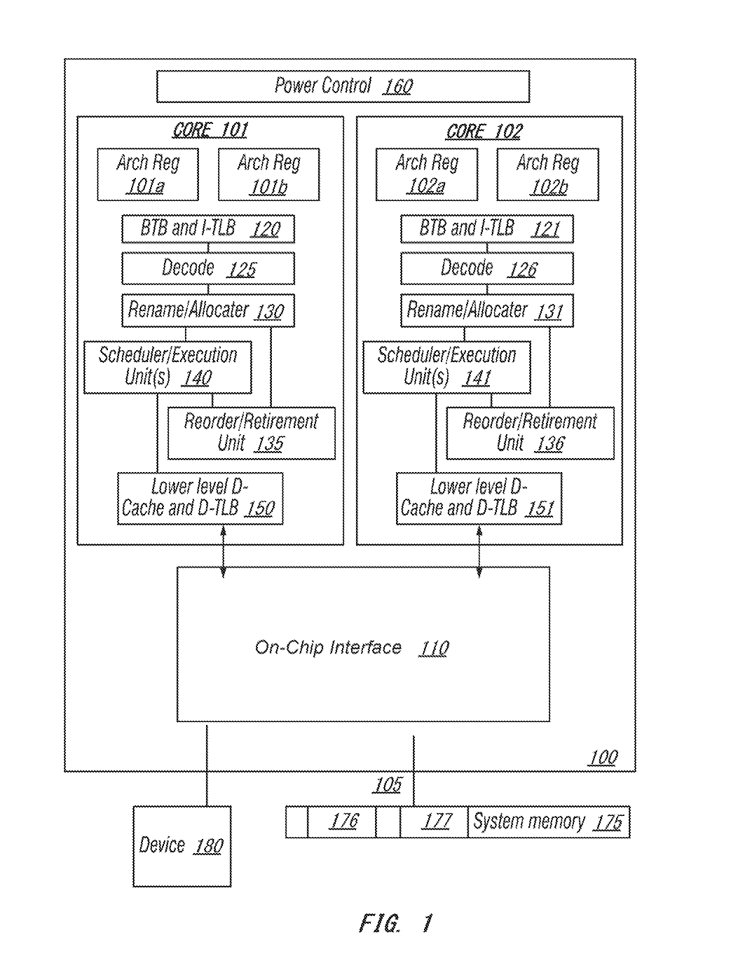

Referring to FIG. 1, an embodiment of a block diagram for a computing system including a multicore processor is depicted. Processor 100 includes any processor or processing device, such as a microprocessor, an embedded processor, a digital signal processor (DSP), a network processor, a handheld processor, an application processor, a co-processor, a system on a chip (SOC), or other device to execute code. Processor 100, in one embodiment, includes at least two cores—core 101 and 102, which may include asymmetric cores or symmetric cores (the illustrated embodiment). However, processor 100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores—core 101 and 102. Here, core 101 and 102 are considered symmetric cores, i.e. cores with the same configurations, functional units, and/or logic. In another embodiment, core 101 includes an out-of-order processor core, while core 102 includes an in-order processor core. However, cores 101 and 102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 101 are described in further detail below, as the units in core 102 operate in a similar manner in the depicted embodiment.

As depicted, core 101 includes two hardware threads 101a and 101b, which may also be referred to as hardware thread slots 101a and 101b. Therefore, software entities, such as an operating system, in one embodiment potentially view processor 100 as four separate processors, i.e., four logical processors or processing elements capable of executing four software threads concurrently. As alluded to above, a first thread is associated with architecture state registers 101a, a second thread is associated with architecture state registers 101b, a third thread may be associated with architecture state registers 102a, and a fourth thread may be associated with architecture state registers 102b. Here, each of the architecture state registers (101a, 101b, 102a, and 102b) may be referred to as processing elements, thread slots, or thread units, as described above. As illustrated, architecture state registers 101a are replicated in architecture state registers 101b, so individual architecture states/contexts are capable of being stored for logical processor 101a and logical processor 101b. In core 101, other smaller resources, such as instruction pointers and renaming logic in allocator and renamer block 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register(s), low-level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 includes a simplified, representative out-of-order (OOO) processor core. But an in-order processor may be utilized in different embodiments. The OOO core includes a branch target buffer 120 to predict branches to be executed/taken and an instruction-translation buffer (I-TLB) 120 to store address translation entries for instructions.

Core 101 further includes decode module 125 coupled to fetch unit 120 to decode fetched elements. Fetch logic, in one embodiment, includes individual sequencers associated with thread slots 101a, 101b, respectively. Usually core 101 is associated with a first ISA, which defines/specifies instructions executable on processor 100. Often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA. For example, as discussed in more detail below decoders 125, in one embodiment, include logic designed or adapted to recognize specific instructions, such as transactional instruction. As a result of the recognition by decoders 125, the architecture or core 101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 126, in one embodiment, recognize the same ISA (or a subset thereof). Alternatively, in a heterogeneous core environment, decoders 126 recognize a second ISA (either a subset of the first ISA or a distinct ISA).

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 101 and 102 share access to higher-level or further-out cache, such as a second level cache associated with on-chip interface 110. Note that higher-level or further-out refers to cache levels increasing or getting further way from the execution unit(s). In one embodiment, higher-level cache is a last-level data cache—last cache in the memory hierarchy on processor 100—such as a second or third level data cache. However, higher level cache is not so limited, as it may be associated with or include an instruction cache. A trace cache—a type of instruction cache—instead may be coupled after decoder 125 to store recently decoded traces. Here, an instruction potentially refers to a macro-instruction (i.e. a general instruction recognized by the decoders), which may decode into a number of micro-instructions (micro-operations).

In the depicted configuration, processor 100 also includes on-chip interface module 110. Historically, a memory controller, which is described in more detail below, has been included in a computing system external to processor 100. In this scenario, on-chip interface 11 is to communicate with devices external to processor 100, such as system memory 175, a chipset (often including a memory controller hub to connect to memory 175 and an I/O controller hub to connect peripheral devices), a memory controller hub, a northbridge, or other integrated circuit. And in this scenario, bus 105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 175 may be dedicated to processor 100 or shared with other devices in a system. Common examples of types of memory 175 include DRAM, SRAM, non-volatile memory (NV memory), and other known storage devices. Note that device 180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 100. For example in one embodiment, a memory controller hub is on the same package and/or die with processor 100. Here, a portion of the core (an on-core portion) 110 includes one or more controller(s) for interfacing with other devices such as memory 175 or a graphics device 180. The configuration including an interconnect and controllers for interfacing with such devices is often referred to as an on-core (or un-core configuration). As an example, on-chip interface 110 includes a ring interconnect for on-chip communication and a high-speed serial point-to-point link 105 for off-chip communication. Yet, in the SOC environment, even more devices, such as the network interface, co-processors, memory 175, graphics processor 180, and any other known computer devices/interface may be integrated on a single die or integrated circuit to provide small form factor with high functionality and low power consumption.

In one embodiment, processor 100 is capable of executing a compiler, optimization, and/or translator code 177 to compile, translate, and/or optimize application code 176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

One interconnect fabric architecture that has been developed to interface system components includes the Peripheral Component Interconnect (PCI) Express (PCIe) architecture. A goal of PCIe is to enable components and devices from different vendors to inter-operate in an open architecture, spanning multiple market segments; Clients (Desktops and Mobile), Servers (Standard and Enterprise), and Embedded and Communication devices. PCI Express is often referred to as a load-store, I/O, or load-store I/O interconnect architecture defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express takes advantage of advances in point-to-point interconnects, switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express (PCIe). However, the protocols defined in the specifications of PCIe may be utilized over any physical interface or topology—point-to-point, ring, mesh, cluster, etc.

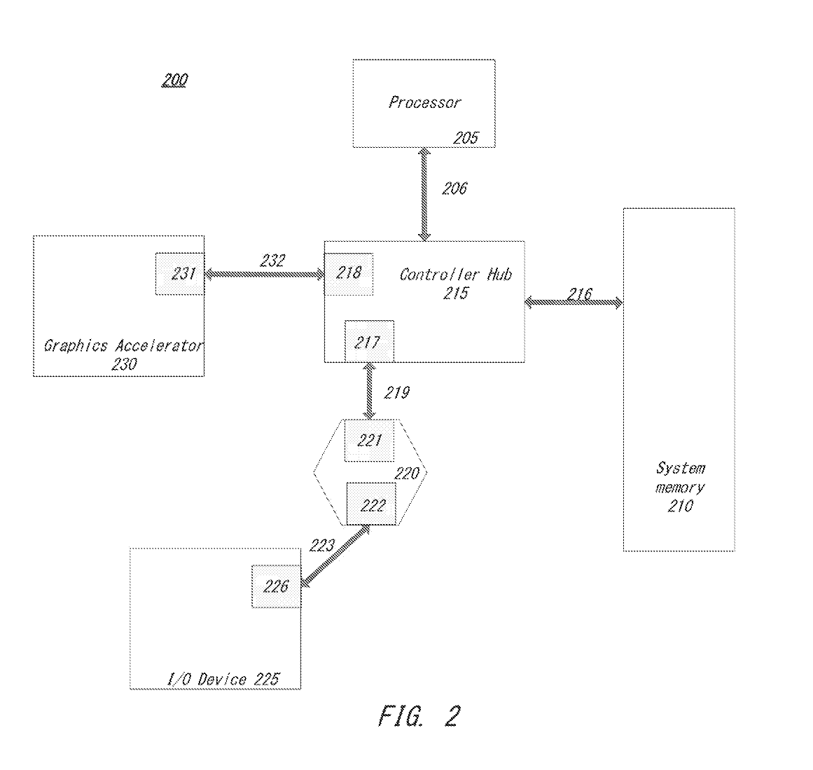

Referring to FIG. 2, an embodiment of a fabric composed of point-to-point links that interconnect a set of components is illustrated. System 200 includes processor 205 and system memory 210 coupled to controller hub 215. Processor 205 includes any processing element, such as a microprocessor, a host processor, an embedded processor, a co-processor, or other processor. Processor 205 is coupled to controller hub 215 through front-side bus (FSB) 206. In one embodiment, FSB 206 is a serial point-to-point interconnect as described below. In another embodiment, link 206 includes a serial, differential interconnect architecture that is compliant with different interconnect standard.

As more devices are being integrated on the same die with processor 205, it's important to note that in some implementations controller hub 215 is integrated with processor 205. Here, cores of processor 205 interface with a memory controller hub 215, which is integrated on die. Furthermore, PCIe interfaces may be provided directly from processor 205, from controller hub 215 integrated on processor 205, or both.

System memory 210 includes any memory device, such as random access memory (RAM), non-volatile (NV) memory, or other memory accessible by devices in system 200. System memory 210 is coupled to controller hub 215 through memory interface 216. Examples of a memory interface include a double-data rate (DDR) memory interface, a dual-channel DDR memory interface, and a dynamic RAM (DRAM) memory interface.

In one embodiment, controller hub 215 is a root hub, root complex, or root controller in a Peripheral Component Interconnect Express (PCIe or PCIE) interconnection hierarchy. Examples of controller hub 215 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). As stated above, many current systems often include the MCH integrated with processor 205, while controller 215 may be separately provided within or external to processor 205 to communicate with I/O devices, in a similar manner as described below. In some embodiments, peer-to-peer routing is optionally supported through root complex 215. In one embodiment, root complex 215 includes a logical aggregation of root ports, root complex register blocks, or root complex integrated endpoints.

Here, controller hub 215 is coupled to switch/bridge 220 through serial link 219. Input/output modules 217 and 221, which may also be referred to as interfaces/ports 217 and 221, include/implement a layered protocol stack to provide communication between controller hub 215 and switch 220. In one embodiment, multiple devices are capable of being coupled to switch 220.

Switch/bridge 220 routes packets/messages from device 225 upstream, i.e. up a hierarchy towards a root complex, to controller hub 215 and downstream, i.e. down a hierarchy away from a root controller, from processor 205 or system memory 210 to device 225. Upstream, as used in this example, includes a relative position of an element that is closer to the root complex or a direction of information flow towards the root complex, while downstream inversely refers to an element that is further away from a root complex or a direction of information flow away from the root complex. Switch 220, in one embodiment, is referred to as a logical assembly of multiple virtual PCI-to-PCI bridge devices. Here switch 220 is illustrated as a system element to connect two or more ports to allow packets to be routed from one port to another and, in some implementations, may appear as a collection of PCI-PCI bridges. A bridge, i.e. a stand-alone bridge, typically refers to a function that virtually or actually connects a PCI/PCI-X segment or PCIe port with an internal component interconnect or with another PCI/PCI-X bus segment or PCIe port.

Device 225 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 225 may include a PCIe to PCI/PCI-X bridge to support legacy or other version PCI devices. Endpoint devices in PCIe are often classified as legacy, PCIe, or root complex integrated endpoints. In one embodiment, device 225 includes a physical or logical entity that is to perform a type of I/O, a component on either end of a link, or a reference to a function (or collection of functions in a multi-function device). Often in PCIe a more common usage for an element or entity on a PCIe link is referred to as a function. Here a function typically refers to an addressable entity in a configuration space associated with a function number. In some embodiments, a function refers to a single function device, while in others it refers to a multi-function device.

Graphics accelerator 230 is also coupled to controller hub 215 through serial link 232. In one embodiment, graphics accelerator 230 is coupled to an MCH, which is coupled to an ICH. Switch 220, and accordingly I/O device 225, is then coupled to the ICH. I/O modules 231 and 218 are also to implement a layered protocol stack to communicate between graphics accelerator 230 and controller hub 215. Similar to the MCH discussion above, a graphics controller or the graphics accelerator 230 itself may be integrated in processor 205.

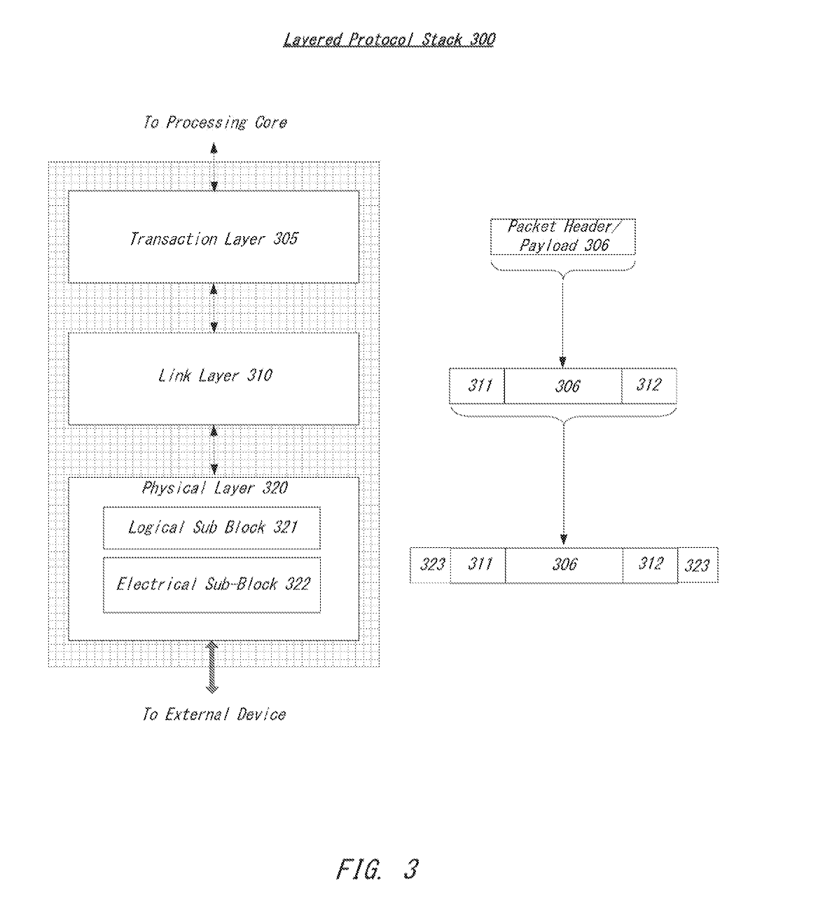

Turning to FIG. 3 an embodiment of a layered protocol stack is illustrated. Layered protocol stack 300 includes any form of a layered communication stack, such as a Quick Path Interconnect (QPI) stack, a PCie stack, a next generation high performance computing interconnect stack, a low powered interface stack, a Mobile Industry Processor Interface (MIPI), or other layered stack. Although the discussion immediately below in reference to FIGS. 2-5 are in relation to a PCIe stack, the same concepts may be applied to other interconnect stacks. In one embodiment, protocol stack 300 is a PCIe protocol stack including transaction layer 305, link layer 310, and physical layer 320. An interface, such as interfaces 217, 218, 221, 222, 226, and 231 in FIG. 1, may be represented as communication protocol stack 300. Representation as a communication protocol stack may also be referred to as a module or interface implementing/including a protocol stack.

PCI Express uses packets to communicate information between components. Packets are formed in the Transaction Layer 305 and Data Link Layer 310 to carry the information from the transmitting component to the receiving component. As the transmitted packets flow through the other layers, they are extended with additional information necessary to handle packets at those layers. At the receiving side the reverse process occurs and packets get transformed from their Physical Layer 320 representation to the Data Link Layer 310 representation and finally (for Transaction Layer Packets) to the form that can be processed by the Transaction Layer 305 of the receiving device.

Transaction Layer

In one embodiment, transaction layer 305 is to provide an interface between a device's processing core and the interconnect architecture, such as data link layer 310 and physical layer 320. In this regard, a primary responsibility of the transaction layer 305 is the assembly and disassembly of packets (i.e., transaction layer packets, or TLPs). The translation layer 305 typically manages credit-base flow control for TLPs. PCIe implements split transactions, i.e. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 305. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message space transactions (or, simply messages) are defined to support in-band communication between PCIe agents.

Therefore, in one embodiment, transaction layer 305 assembles packet header/payload 306. Format for current packet headers/payloads may be found in the PCIe specification at the PCIe specification website.

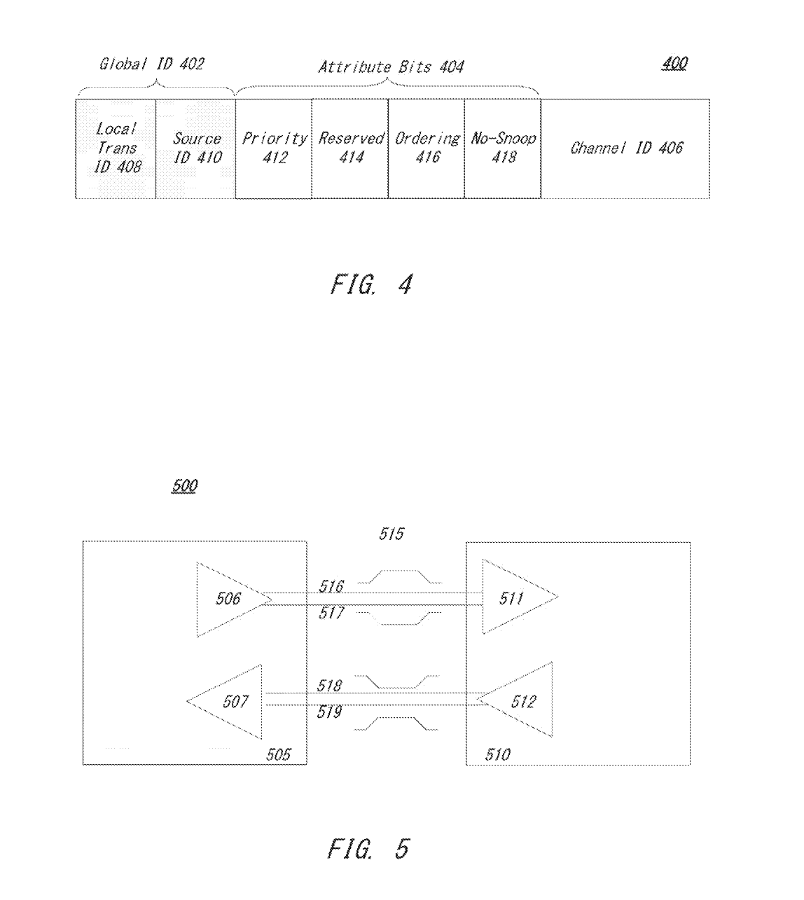

Quickly referring to FIG. 4, an embodiment of a PCIe transaction descriptor is illustrated. In one embodiment, transaction descriptor 400 is a mechanism for carrying transaction information. In this regard, transaction descriptor 400 supports identification of transactions in a system. Other potential uses include tracking modifications of default transaction ordering and association of transaction with channels.

Transaction descriptor 400 includes global identifier field 402, attributes field 404 and channel identifier field 406. In the illustrated example, global identifier field 402 is depicted comprising local transaction identifier field 408 and source identifier field 410. In one embodiment, global transaction identifier 402 is unique for all outstanding requests.

According to one implementation, local transaction identifier field 408 is a field generated by a requesting agent, and it is unique for all outstanding requests that require a completion for that requesting agent. Furthermore, in this example, source identifier 410 uniquely identifies the requestor agent within a PCIe hierarchy. Accordingly, together with source ID 410, local transaction identifier 408 field provides global identification of a transaction within a hierarchy domain.

Attributes field 404 specifies characteristics and relationships of the transaction. In this regard, attributes field 404 is potentially used to provide additional information that allows modification of the default handling of transactions. In one embodiment, attributes field 404 includes priority field 412, reserved field 414, ordering field 416, and no-snoop field 418. Here, priority sub-field 412 may be modified by an initiator to assign a priority to the transaction. Reserved attribute field 414 is left reserved for future, or vendor-defined usage. Possible usage models using priority or security attributes may be implemented using the reserved attribute field.

In this example, ordering attribute field 416 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 418 is utilized to determine if transactions are snooped. As shown, channel ID Field 406 identifies a channel that a transaction is associated with.

Link Layer

Link layer 310, also referred to as data link layer 310, acts as an intermediate stage between transaction layer 305 and the physical layer 320. In one embodiment, a responsibility of the data link layer 310 is providing a reliable mechanism for exchanging Transaction Layer Packets (TLPs) between two components a link. One side of the Data Link Layer 310 accepts TLPs assembled by the Transaction Layer 305, applies packet sequence identifier 311, i.e. an identification number or packet number, calculates and applies an error detection code, i.e. CRC 312, and submits the modified TLPs to the Physical Layer 320 for transmission across a physical to an external device.

Physical Layer

In one embodiment, physical layer 320 includes logical sub block 321 and electrical sub-block 322 to physically transmit a packet to an external device. Here, logical sub-block 321 is responsible for the “digital” functions of Physical Layer 321. In this regard, the logical sub-block includes a transmit section to prepare outgoing information for transmission by physical sub-block 322, and a receiver section to identify and prepare received information before passing it to the Link Layer 310.

Physical block 322 includes a transmitter and a receiver. The transmitter is supplied by logical sub-block 321 with symbols, which the transmitter serializes and transmits onto to an external device. The receiver is supplied with serialized symbols from an external device and transforms the received signals into a bit-stream. The bit-stream is de-serialized and supplied to logical sub-block 321. In one embodiment, an 8b/10b transmission code is employed, where ten-bit symbols are transmitted/received. Here, special symbols are used to frame a packet with frames 323. In addition, in one example, the receiver also provides a symbol clock recovered from the incoming serial stream.

As stated above, although transaction layer 305, link layer 310, and physical layer 320 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized.

Referring next to FIG. 5, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 506/511 and a receive pair 512/507. Accordingly, device 505 includes transmission logic 506 to transmit data to device 510 and receiving logic 507 to receive data from device 510. In other words, two transmitting paths, i.e. paths 516 and 517, and two receiving paths, i.e. paths 518 and 519, are included in a PCIe link.

A transmission path refers to any path for transmitting data, such as a transmission line, a copper line, an optical line, a wireless communication channel, an infrared communication link, or other communication path. A connection between two devices, such as device 505 and device 510, is referred to as a link, such as link 415. A link may support one lane—each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider.

A differential pair refers to two transmission paths, such as lines 416 and 417, to transmit differential signals. As an example, when line 416 toggles from a low voltage level to a high voltage level, i.e. a rising edge, line 417 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

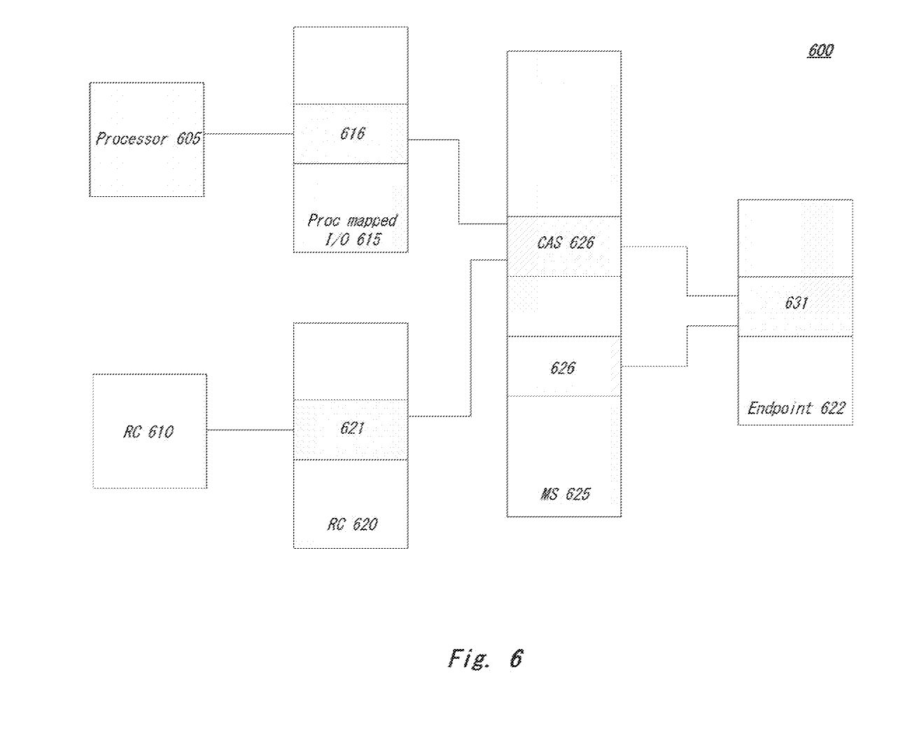

Turning to FIG. 6, embodiments of a logical view for a memory mapped configuration space is depicted. A few of these examples of memory mapped configuration spaces are discussed immediately below in reference to FIG. 6. Here, the PCI architecture defines and provides for a configuration address space 626 in memory 625, which is typically orthogonal to an I/O and memory address space 626.

In one embodiment, a mechanism is provided for configuration read and write generation using an I/O mapped address data window 616 located at a fixed address, such as CFC/CF8 in processor 605's I/O space 615. Here, processor issues a read or write to address space 616, which is representative of a configuration address space 626. And that read or write is then performed at endpoint 622, which may be a device or function within the PCIe network.

In another embodiment, an Enhanced Configuration Access Mechanism (ECAM) is provided to enhance PCIe device or function configuration. Here, root complex 610 is associated with a memory mapped window 621 in a root complex memory space to represent configuration access space 626 and to generate configuration read/write bus semantic requests. Exemplary embodiments of ECAM implementations is discussed immediately below to provide a more detailed illustration of ECAM inner workings. However, ECAM implementation is not so limited. Furthermore, as discussed below, an FCAM may utilize attributes similar to ECAM, such that the example below may help to understand a FCAM framework; yet, a FCAM is also not limited to the detailed, illustrative example.

In one ECAM implementation, often to maintain compatibility with PCI software configuration mechanisms, PCI Express elements, such as device 622, are associated with a PCI-compatible Configuration Space 626. Some examples are now described. A PCI Express Link originates from a logical PCI-PCI Bridge and is mapped into configuration space 626 as the secondary bus of this Bridge. The Root Port in root complex 610 is a PCI-PCI Bridge structure that originates a PCI Express Link from a PCI Express Root Complex 610. A PCI Express Switch is represented by multiple PCI-PCI Bridge structures connecting PCI Express Links to an internal logical PCI bus. The Switch Upstream Port includes a PCI-PCI Bridge; the secondary bus of this Bridge represents the Switch's internal routing logic. Switch Downstream Ports are PCI-PCI Bridges bridging from the internal bus to buses representing the Downstream PCI Express Links from a PCI Express Switch. The PCI-PCI Bridges representing the Switch Downstream Ports may appear on the internal bus. Endpoints 622, represented by Type 0 Configuration Space headers, are not permitted, in some implementations, to appear on the internal bus.

A PCI Express Endpoint 622 may be mapped into Configuration Space 626 as a single Function in a Device, which might contain multiple Functions or just that Function. PCI Express Endpoints and Legacy Endpoints often appear within one of the Hierarchy Domains originated by the Root Complex 610. As an example, devices 622 appear in Configuration Space 626 in a tree that has a Root Port as its head. Root Complex Integrated Endpoints and Root Complex Event Collectors may not appear within one of the Hierarchy Domains originated by the Root Complex 610. Instead, in some implementations, these appear in Configuration Space 626 as peers of the Root Ports.

PCI Express, in one embodiment, extends the Configuration Space 626 to a larger size, such as 4096 bytes per Function as compared to 256 bytes allowed by a PCI Local Bus Specification. PCI Express Configuration Space 626, in one embodiment, is divided into a PCI 3.0 compatible region, which consists of the first amount, such as the first 256 bytes, of a Function 622's Configuration Space, and a PCI Express Extended Configuration Space which consists of the remaining Configuration Space 626. The PCI 3.0 compatible portion of Configuration Space 626 can be accessed using either the mechanism defined in the PCI Local Bus Specification or the PCI Express Enhanced Configuration, Access Mechanism (ECAM) or Fast Configuration Access Mechanism (FCAM), as described later.

The PCI Express Extended Configuration Space may be accessed by using the ECAM or FCAM. The PCI 3.0, or later (e.g. 4.0, 5.0, and others to be developed.), compatible PCI Express Configuration Mechanism supports the PCI Configuration Space programming model defined in the PCI Local Bus Specification. By adhering to this model, systems incorporating PCI Express interfaces remain compliant with conventional PCI bus enumeration and configuration software. In the same manner as PCI 3.0 device Functions, PCI Express device Functions provide a Configuration Space for software-driven initialization and configuration. The PCI Express Configuration Space 626's headers are typically organized to correspond with the format and behavior defined in the PCI Local Bus Specification. The PCI 3.0 compatible Configuration Access Mechanism may use the same Request format as the ECAM or FCAM. For PCI compatible Configuration Requests, the Extended Register Address field may be set to all zeros.

In one embodiment, for systems that implement a processor-architecture-specific firmware interface standard that allows access to the Configuration Space 626, the operating system uses the standard firmware interface, and ECAM or FCAM access is optional. For example, for systems that are compliant with Developer's Interface Guide for 64-bit Intel Architecture-based Servers (DIG64), Version 2.1,93 the operating system uses the SAL firmware service to access the Configuration Space.

In one embodiment, the ECAM utilizes a flat memory-mapped address space to access device 622's configuration registers. In this case, the memory address determines the configuration register accessed and the memory data updates (for a write) or returns the contents of (for a read) the addressed register. One exemplary mapping from memory address space to PCI Express Configuration Space address is defined in Table 1.

TABLE 1
Embodiment of Enhanced Configuration Address Mapping

| Memory Address⁹⁴ | PCI Express Configuration Space |
|---|---|
| A[(20 + n − 1):20] | Bus Number 1 ≦ n ≦ 8 |
| A[19:15] | Device Number |
| A[14:12] | Function Number |
| A[11:8] | Extended Register Number |
| A[7:2] | Register Number |
| A[1:0] | Along with size of the access, used to |
| | generate Byte Enables |

The size and base address for the range of memory addresses mapped to the Configuration Space are determined by the design of the host bridge and the firmware. They may be reported by the firmware to the operating system in an implementation-specific manner. The size of the range is determined by the number of bits that the host bridge maps to the Bus Number field in the configuration address. In Table 1, this number of bits is represented as n, where 1≦n≦8. A host bridge that maps n memory address bits to the Bus Number field supports Bus Numbers from 0 to 2n−1, inclusive, and the base address of the range is aligned to a 2(n+20)-byte memory address boundary. Any bits in the Bus Number field that are not mapped from memory address bits may be Clear.

For example, if a system maps three memory address bits to the Bus Number field, the following may be true: n=3; Address bits A[63:23] are used for the base address, which is aligned to a 2̂23-byte (8-MB) boundary; Address bits A[22:20] are mapped to bits [2:0] in the Bus Number field; Bits [7:3] in the Bus Number field are set to Clear; and the system is capable of addressing Bus Numbers between 0 and 7, inclusive.

A minimum of one memory address bit (n=1) may be mapped to the Bus Number field. However, systems, in other implementations, map additional memory address bits to the Bus Number field as needed to support a larger number of buses. Systems that support more than 4 GB of memory addresses, for example, map at least eight bits of memory address (n=8) to the Bus Number field. Note that in systems that include multiple host bridges with different ranges of Bus Numbers assigned to each host bridge, the highest Bus Number for the system is potentially limited by the number of bits mapped by the host bridge to which the highest bus number is assigned. In such a system, the highest Bus Number 5 assigned to a particular host bridge would be greater, in most cases, than the number of buses assigned to that host bridge. In other words, for each host bridge, the number of bits mapped to the Bus Number field, n, should be large enough that the highest Bus Number assigned to each particular bridge is less than or equal to 2n−1 for that bridge. In some processor architectures, it is possible to generate memory accesses that are not expressed in a single Configuration Request, for example due to crossing a DW aligned boundary, or because a locked access is used. A Root Complex implementation may not be used to support the translation to Configuration Requests of such accesses.

As an aside, Requests may target Extended Functions in an ARI Device, A[19:12] represents the (8-bit) Function Number, which replaces the (5-bit) Device Number and (3-bit) Function Number fields.

The system hardware, in one embodiment, provides a method for the system software to ensure that a write transaction using the ECAM is completed by the completer before system software execution continues.

In one implementation, the ECAM converts memory transactions from the host CPU into Configuration Requests on the PCI Express fabric. This conversion potentially creates ordering problems for the software, because writes to memory addresses are typically posted transactions but writes to Configuration Space may not be posted on the PCI Express fabric.

Generally, software does not know when a posted transaction is completed by the completer. In those cases in which the software wants to know that a posted transaction is completed by the completer, one technique commonly used by the software is to read the location that was just written. For systems that follow the PCI ordering rules throughout, the read transaction will not complete until the posted write is complete. However, since the PCI ordering rules allow non-posted write and read transactions to be reordered with respect to each other, the CPU 605 should wait for a non-posted write to complete on the PCI Express fabric to be guaranteed that the transaction is completed by the completer. As an example, software may wish to configure a device Function 622's Base Address register by writing to the device 622 using the ECAM, and then read a location in the memory-mapped range described by this Base Address register. If the software were to issue the memory-mapped read before the ECAM write was completed, it would be possible for the memory-mapped read to be re-ordered and arrive at the device before the Configuration Write Request, thus causing unpredictable results. To avoid this problem, processor 605 and host bridge 610 implementations, in one embodiment, ensure that a method exists for the software to determine when the write using the ECAM is completed by the completer.

This method may simply be that the processor 605 itself recognizes a memory range dedicated for mapping ECAM accesses as unique, and treats accesses to this range in the same manner that it would treat other accesses that generate non-posted writes on the PCI Express fabric, i.e., that the transaction is not posted from the processor's viewpoint. An alternative mechanism is for the host bridge 610 (rather than the processor 605) to recognize the memory-mapped Configuration Space 626's accesses and not to indicate to the processor 605 that this write has been accepted until the non-posted Configuration Transaction has completed on the PCI Express fabric. A third alternative would be for the processor 605 and host bridge 610 to post the memory-mapped write to the ECAM and for the host bridge 610 to provide a separate register that the software can read to determine when the Configuration Write Request has completed on the PCI Express fabric. Other alternatives are also possible. For example, a processor may provide a fence instruction that, when executed, ensure previous (issued earlier) memory access operations have completed.

Because Root Complex implementations are not required to support the generation of Configuration Requests from accesses that cross DW boundaries, or that use locked semantics, software should take care not to cause the generation of such accesses when using the memory mapped ECAM unless it is known that the Root Complex 610 implementation being used will support the translation. For those systems that implement the ECAM, the PCI Express Host Bridge 610 is to translate the memory-mapped PCI Express Configuration Space accesses from the host processor to PCI Express configuration transactions. The use of Host Bridge PCI class code may be Reserved for backwards compatibility; host Bridge Configuration Space may be implemented in an implementation specific manner that is either compatible or not compatible with PCI Host Bridge Type 0 Configuration Space. A PCI Express Host Bridge may not be required to signal errors through a Root Complex Event Collector. This support is optional for PCI Express Host Bridges. Device 622 may support an additional 4 bits for decoding configuration register access, i.e., decode the Extended Register Address[3:0] field of the Configuration Request header.

Device-specific registers that have legitimate reasons to be placed in Configuration Space (e.g., they are to be accessible before Memory Space is allocated) may be placed in a Vendor-Specific Capability structure (in PCI Compatible Configuration Space) or a Vendor-Specific Extended Capability structure (in PCI Express Extended Configuration Space). Device-specific registers accessed in the run-time environment by drivers may be placed in Memory Space that is allocated by one or more Base Address registers. Even though PCI Compatible or PCI Express Extended Configuration Space may have adequate room for run-time device-specific registers, placing them there is often discouraged

A Root Port or Root Complex Integrated Endpoint may be associated with an optional block of memory mapped registers referred to as the Root Complex Register Block (RCRB), such as a 4096-byte block. These registers, in one embodiment, are used in a manner similar to Configuration Space 626 and may include PCI Express Extended Capabilities and other implementation specific registers that apply to the Root Complex.

Multiple Root Ports or internal devices may be permitted to be associated with the same RCRB. The RCRB memory-mapped registers, in one implementation, do not reside in the same address space as the memory-mapped Configuration Space or Memory Space. In another embodiment, they reside in the same address space but have different addresses.

As can be seen, an ECAM potentially enables faster completion of CPU generated configuration requests to reduce CPU stall times and configuration caching hidden from system software allowing faster power state entry and exit. However, in some embodiments, such benefits are not extended to integrated devices.

As a result, in one embodiment, a Fast Configuration Access Mechanism (FCAM) is provided. As an example, an FCAM implementation includes transparently appearing to host software as ECAM, as root complex 610 applies new FCAM polies to servicing configuration requests. Furthermore, root complex 610, in some embodiments, also generate new bus semantics using memory read/write commands, as well as potentially providing a template for such commands.

In one embodiment, root complex 610 includes a cache, e.g. an FCAM cache, mapped to a memory mapped I/O window. Such cache usage potentially enables one or more of the following: (1) host initiated configuration writes that are buffered in the cache and complete more quickly from host processor 205's perspective; (2) multiple host initiated configuration writes that may be combinable into a single bus transaction to device 622 improving efficiency and reducing configuration time; (3) host initiated reads from static and semi-static device configuration registers that are serviced from cache, reducing latency, reducing bus traffic, and reducing power; and (4) device 622 may be powered-off and then quickly re-establish configuration context by retaining context in the cache, which is then rapidly dumped to device 622 when it is powered back on (this may be done in parallel if multiple devices are being powered-on) and may not require direct host involvement, reducing power and latency.

In one embodiment, an FCAM cache is not cache coherent with processor 605's cache. As a corollary, the ability to provide a non-coherent cache may enable the implementation of the caching mechanism behind a non-coherent 1/O link, such as in a bridge to support legacy PCI/PCIe hardware. However, in another embodiment, the FCAM cache is implemented as coherent with processor 605's cache.

In one embodiment, the FCAM cache implements a write-through policy to ensure configuration updates are sent on to the target function. Yet, the write-through policy may take on any various forms. For example, one implementation potentially utilizes a slothful write-through policy where writes are written through in a reasonably timely fashion, i.e. delays due to congestion, etc. Yet, in this scenario writes may complete deterministically.

In one embodiment, upon re-establishing configuration context, such as reloading a configuration context into a configuration space for an endpoint device from the FCAM cache, a host is permitted to issue large block writes to the target function/device. Here, a configuration space itself could be written to from the cache or from the processor using a block write instead of a smaller write, such as a DW (or smaller) write.

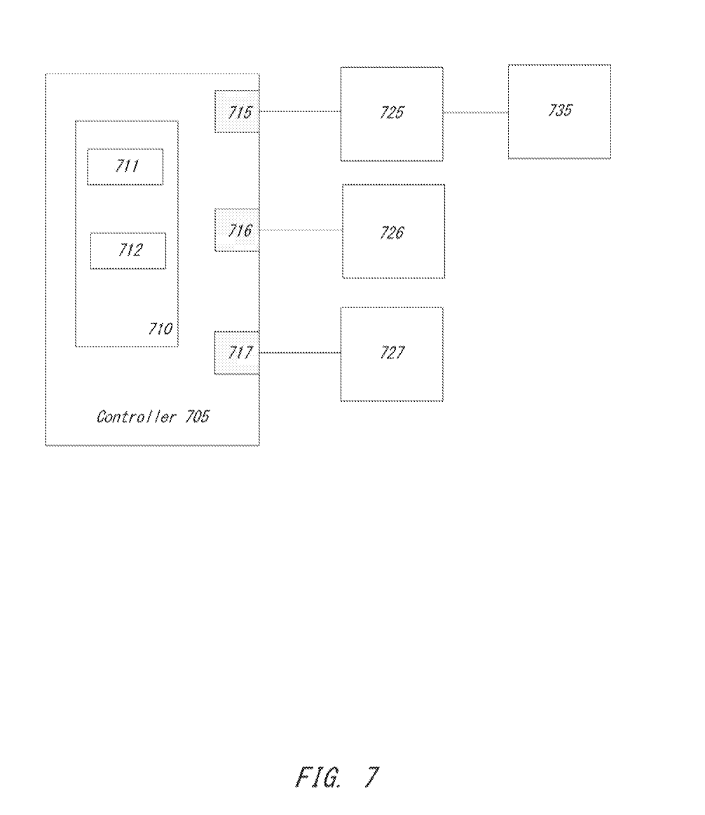

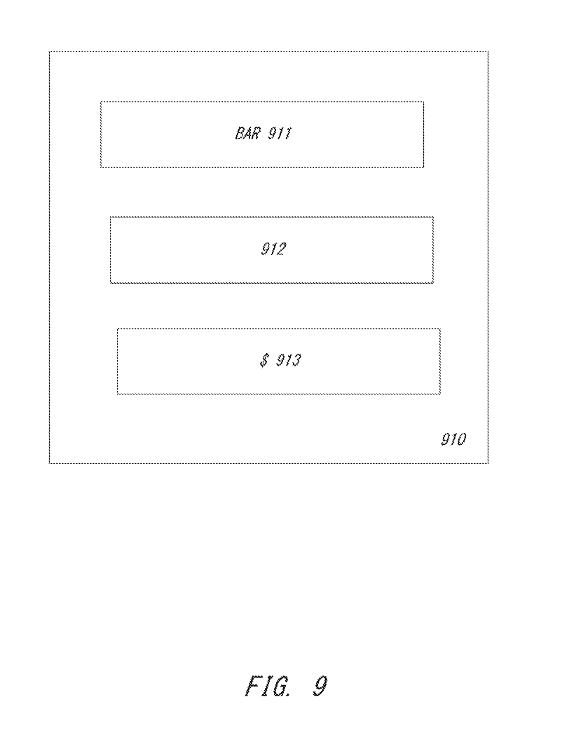

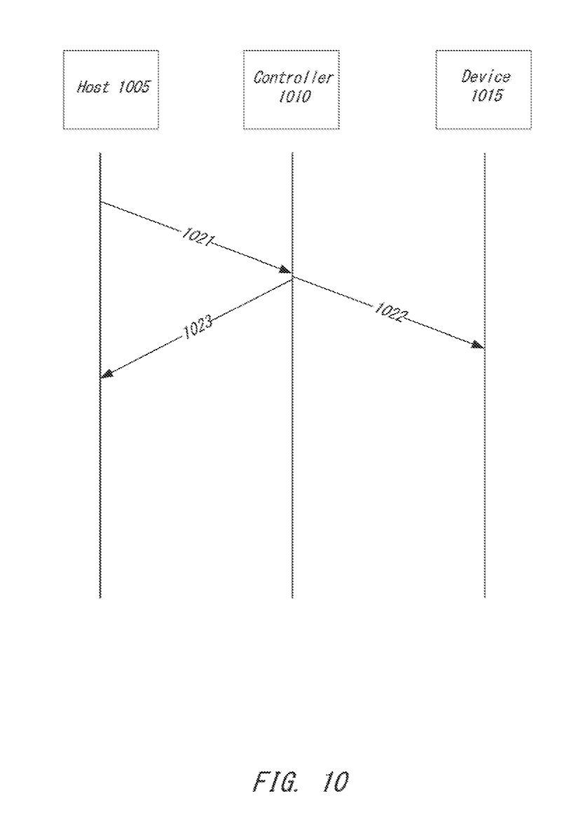

An FCAM cache and restoring configuration context therefrom is discussed in more detail below, such as in reference to FIGS. 7 and 9.

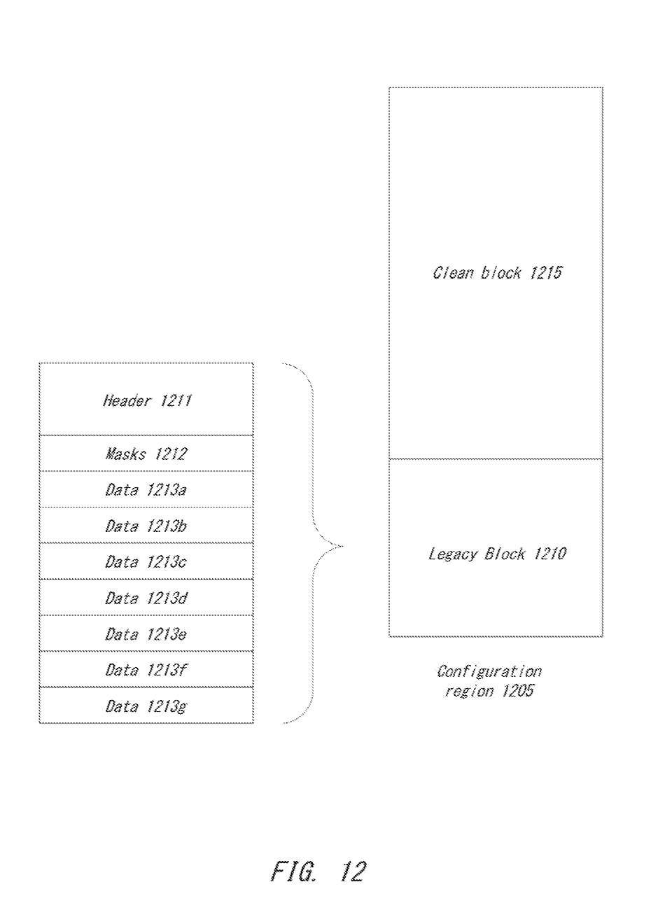

In one embodiment, at least two types of configuration blocks are defined: legacy and clean. In an illustrative example, byte write masks are tracked and sent along with write data in legacy block configuration areas and successive writes are issued distinctly. Additionally, in this example, legacy compatible configuration registers are implemented within the legacy block. The clean block, on the other hand, may not utilize byte write masks. Here, write combining, merging, collapsing, or some combination thereof is potentially permitted/enabled. Furthermore, implementers may include some legacy compatible configuration registers to be accessible in both the clean and legacy blocks provided they adhere to clean block area requirements. Legacy and clean blocks are discussed in more detail below, such as in reference to FIG. 12.

In one embodiment, an FCAM capable device implements a mirror of the host FCAM cache at an offset address. Here, the FCAM mirror cache may also implement a slothful write-through policy that reflects local updates back to the host.

In one embodiment, FCAM configuration traffic uses memory write semantics. As a result, in some implementations, translation of such memory write semantics is utilized for legacy PCI/PCIe functions. As a specific illustrative example of translation, writes work as described above, yet the configuration space for the legacy device 622 is treated as a legacy block and the memory write semantic is converted to a configuration write, such as a legacy configuration write; and reads are not serviced from the FCAM cache and are passed through to legacy device 622. In one scenario, FCAM capable devices self-identify through use of a unique message, such as a Device Readiness Status (DRS)-like or Function Readiness Status (FRS) message mechanism or a Configuration Base Address Register (CBAR) like message mechanism.

As noted above, a fast configuration mechanism may be performed for traditional non-integrated functions/devices, as well as for integrated functions/devices, such as in a System on a Chip (SoC). For the discrete implementation, i.e. where a function is not integrated, an exemplary protocol mechanism is now described. Here, the FCAM mechanisms operate using memory writes to special addresses, e.g. a range associated with the function through a Configuration Base Address Register (CBAR) and another range on the host/root root complex 610 which may be located anywhere in memory. In one embodiment, the CBAR address range is set using a message from host 610 sent in response to a message sent by the device identifying itself as FCAM capable. Continuing the exemplary wire protocol, the CBAR range is committed in-order and is not stalled for extended periods. Additionally, updates from the device to the host's region cause notification of host software, e.g. an interrupt, a trigger to return from a wait state (MWAIT), or some other known mechanism. Moreover, in some implementations, a notification mechanism is provided to trigger action upon a CBAR update.

Referring to FIG. 7, an embodiment of a controller to configure elements of an interconnect architecture is illustrated. In one embodiment, controller 705 includes a root controller. Similarly, controller 705 may be referred to as a root complex, host, host bridge or other name for a high-level hierarchal element that often operates as an aggregation point for root aspects of a PCIe architecture. As a specific illustrative example, root controller 705 includes a memory controller, which may or may not be integrated in a processor or SoC. Controller 705 may also be an I/O controller to be coupled to I/O devices. Or controller 705 may be a logic block on an SoC to interface with an integrated endpoint device 735.

Interface logic 715, 716, and 717 includes logic to interface with elements, such as PCIe devices, bridges, functions, and endpoints. In its most basic form, interface logic 715 includes a physical layer interface for physically coupling to the enumerated devices. However, as stated above, controller 705 may include a layered stack to communicate with devices. Yet, it's important to note that each layer may be based on the same or different specifications. For example, a protocol layer, link layer, and physical layer may be based on one or more PCIe specifications. Or alternatively, at least a portion of the PHY layer may be based on a MIPI PHY speciation, such as the MPHY specification, while the remaining layers are PCIe based. As a result, an interconnect architecture may be PCIe protocol compliant, i.e. substantially compliant with one or more PCIe protocol definitions, while implementing those protocols over a different physically defined interface. Some examples of physical interfaces include: a low power PHY specification, a mobile industry peripheral interface (MIPI) PHY specification, a peripheral component interconnect express (PCIe) PHY specification, and a higher performance and power PHY specification. However, since it's a goal of the layers to abstract their inner workings for each other, any known PHY interface may be utilized. And furthermore, the FCAM may be utilized within another protocol or link layer adaptation that is not PCIe, as describe in more detail below.

FIG. 7 also illustrates a plurality of elements, which may include a device, a function, a switch, a bridge, a peripheral component interconnect express (PCIe) device capable of recognizing a plurality of PCIe specification defined protocol communications, a non PCIe device not capable of recognizing a plurality of PCIe specification defined protocol communication, or other known I/O device. As an example, FIG. 7 illustrates a switch 725 with a legacy translator, as described herein. As a result, assuming device 735 is a legacy function, switch 725 performs the legacy translation of memory write semantics to configuration writes, and memory read semantics to configuration reads, to ensure backwards capability. In this scenario, devices 726 and 727 include FCAM support.

Controller 705 comprises FCAM block 710. FCAM block 710, in one embodiment, includes hardware to support a fast configuration mechanism to configure devices 725, 726, 727, and 735 efficiently. Note that in some embodiments, FCAM block 710 may include collocated code to be locally executed to perform certain operations to support fast configuration as well.

In the depicted embodiment, FCAM block 710 comprises configuration control logic 711 and configuration storage 712. Configuration storage 712, although shown as one logical block, is not so limited. In fact, it may be multiple separate storage elements that are no collocated. As a specific illustrative example, configuration storage 712 may include: a register to store a base address for a configuration space; a cache to cache writes and to implement, in conjunction with control logic 711, the memory write semantics for configuration, and storage/cache for configuration context information itself. Note that one or a combination of these items may be included in controller 705 as configuration storage 712. However, to simplify the discussion each one of the aforementioned examples of configuration storage is discussed separately below.

As a first example, configuration storage 712 includes a cache to service host processor configuration requests. Here, instead of a host processor issuing a configuration write or other write and waiting until full completion (update in the endpoint device and completion notice), the processor can issue a memory write and rely on FCAM block 710 to immediately provide a completion so the host processor can continue execution, while the FCAM block 710 services the memory write as a write to a devices configuration registers/space. In other words, the cache buffers the host initiated configuration write so a completion is able to occur more quickly from the host's perspective. In this embodiment, configuration registers of device 726 are to be mapped to a configuration space in memory and a write to a particular configuration register within device 726 is to address a memory address within the configuration space in memory to be associated with the particular configuration register. And when the write to the memory address is performed, the cache buffers the write, provides a completion to the host, and provides the write to the particular configuration register that is mapped to the memory address of the write. Additionally, the cache may provide other enhancements, such as write combining, merging, and collapsing.

As another example, the configuration storage 712 is to hold a reference to a configuration context. A reference to a configuration context, in one example, refers to a reference to where the configuration space is located. In this example, the reference may include a memory address, pointer, or other known reference to a location for a configuration space. Here, an address register, such as a base address register, may hold an address reference to a memory mapped configuration space to be associated with the element, such as address spaces 626 from FIG. 6. In another embodiment, a reference to a configuration context refers to a location where a cached copy of configuration context is held, such as a memory location or other location. Or in another embodiment a reference to a configuration context includes a reference that associates the configuration context with the device it is associated with. For example, assuming configuration storage 712 holds a cache configuration context for device 726, while device 726 is in a low power state, then in this embodiment a reference to the configuration context includes the configuration context itself in storage 712 and the reference, such as device ID, index, header, etc. that associates the context with device 726 in configuration storage 712.

As yet another example, configuration storage is to hold configuration context. As described herein, a configuration space potentially adheres to a defined template of information. And when a device, such as device 726, enters a lower power state, that configuration space information may be lost. As a result, in one embodiment, that configuration space information is cached to be restored upon device 726 re-entering an active state. Here, the cached context information may be stored anywhere. Therefore, in one embodiment, configuration storage 712 holds a reference to where the cached copy of the configuration space is stored. As a different example, assume device 726 is FCAM capable and switch 725 includes an FCAM cache. The FCAM cache in switch 725 may hold a cached copy of device 726's configuration space. And upon a request to re-enter an active power state, controller 705 may provide that cached copy to rebuild the configuration space for device 726.

In another embodiment, configuration storage 712 holds the configuration context for a device, such as function 726. As a result in this scenario, when device 726 is to enter a low power state, the configuration space (or at least a portion thereof) is stored to configuration storage 712. In other words, the configuration data for the device 726 (whether integrated or discrete) is written to configuration storage 712 and subsequently device 726 enters a low power state. And upon a re-entry to an active state, the configuration context for device 726 is provided without the need for a processor to re-write configuration information using legacy configuration writes. Consequently, the power down and power up of device 726 can occur very fast using the FCAM block 710 without direction intervention or direct access from a host processing device, such as processor 605 from FIG. 6.

As sated above, a configuration context, in one embodiment, comprises a state for a plurality of configuration space parameters for an element, such as device 726. As a result, the context may hold values for registers and parameters for device 726; some of which are described herein, such as in reference to the configuration space template with the legacy and clean blocks. In one embodiment, configuration data comprises data from configuration registers within device 726.

Also as eluded to above, in one embodiment, storing context or restoring (e.g. providing/writing context back from a cached copy) is done in response to a power event. A power event may include an actual change in voltage or power. Yet, in other embodiments, a power event refers to a change in state, a requested change in state, or a transition period between states, such as a change in a state of the link (e.g. a transition from one state of the link's state machine to another or into/out of a defined power state). In the case of storing or backing up context, the power event may include an entry (or indication of entry, such as a request for entry) into a low power state, such as a sleep state (RTD3). For restoring or providing context from a cache copy, such as in cache 712, cache control logic 711 may initiate or provide the context in response to an entry (or indication of an entry, such as a request for entry) into an active power state. Other examples of a power event include an indication that the element is to enter an active power state, an indication that the element is to complete link training, an indication that the element is to complete another phase of link initialization or operation, or an indication that the link is to transition between link states. In one embodiment, an active power state in reference to configuration context is one that is defined to have an active configuration space and a sleep or low power mode is one where configuration space information is to be stored elsewhere due to potential loss of data or power.

Although the blocks of FIG. 7 are illustrated as logically separate and distinct, the actual implementation may not be so distinct, and instead, the boundaries of blocks may overlap or be integrated on the same device. As an illustrative example, all of the blocks (the controller 705 and devices 725, 726, 727, and 735 are integrated on a single die as an SoC. Here the SoC may be included in a system, such as a mobile terminal with standardized voice communication capability or in a non-mobile terminal that may or may not have voice communication capability. As a different example, the controller 705 and devices 726, 727 are together on an integrated circuit, while switch 725 and device 735 are discretely coupled to the integrated circuit. Furthermore, all the devices may be discretely separate. Moreover, the logic blocks, such as 711 and 712, may be interleaved with each other and other blocks, such as the interface logic 715, 716, and 717. In that example, the cache or logic to perform FCAM operation may be included with in the layered stack logic of the interconnect architecture.

As a result, the FCAM block 710 potentially enables: application of fast configuration to both integrated and discrete interconnect devices, reduced sleep resume latencies by reducing host intervention and architectural limitations, simultaneous and independent threads of non-block configuration activity, full virtualization of I/O devices including full support for function extensions, and legacy compatibility mechanisms for existing software and hardware.

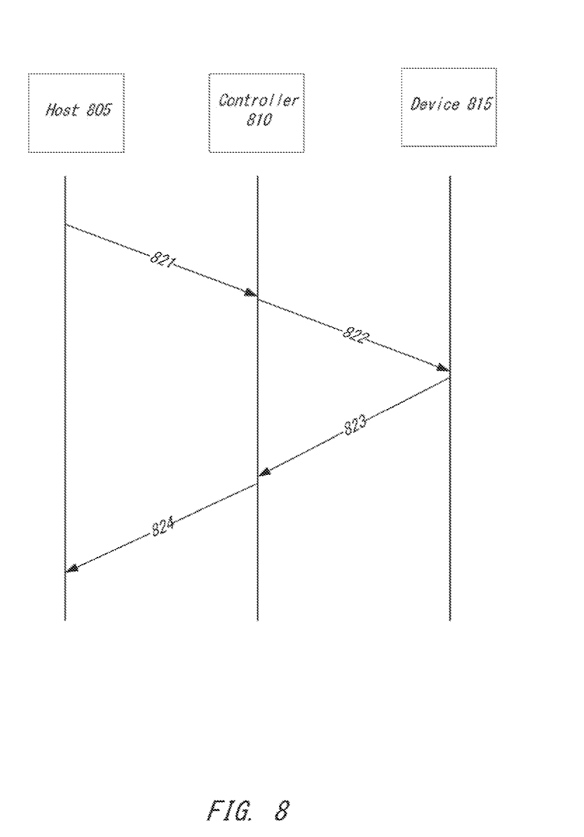

FIG. 8 illustrates an embodiment of a protocol diagram for configuring an element using memory accesses from a host device. Here, a host 805, such as a processing element, is to configure device 815. Host 805 performs a write 821 that targets device 815. As a first example, write 821 includes a configuration write. Alternatively, write 821 includes a memory write with memory write semantics. In the latter, a memory write 821 may target device 815 using a memory address for the memory write that is to reference a memory address associated with, such as mapped, to a configuration space for, and potentially a specific configuration register within, device 815.

Controller 810 receives write 821. The receipt may be over any link. In one implementation, controller 810 is a controller hub integrated on processor 805. As a result, the receipt of message 821 is from an on die interconnect. However, controller 810 may also be external to host 805, which causes message 821 to be transmitted and received over an interconnect external to host 805.

In one embodiment, controller 810 initiates and transmits a message 822 to device 815. Continuing the example above where a write has an intended target of a configuration register within device 815. The write 822 may take the form of a legacy configuration write or an ECAM-like write to a configuration space or the device register to update with register with a configuration value from write 821.

In one scenario, completions 823 and 824 are sent back to controller 810 and host 805, respectively. As can be seen here, a potential delay (referred to below as host configuration completion delay) exists from host 805's transmission of message 821 to receipt of completion 824 at host 805.

Turning to FIG. 9, an embodiment of configuration logic for fast device configuration is illustrated. In one embodiment, FCAM block 910 includes blocks to accelerate configuration, such as potentially reducing the host configuration completion delay described above, reducing latency for configuration of functions, etc.

Similar to the discussion above, configuration storage may take on many forms, such as storage to hold a reference to a configuration space for a function, storage to hold a reference to configuration context, storage to hold configuration writes, or a combination thereof. At least two types of configuration storage are illustratively provided in FIG. 9. For example, FCAM block 910 includes a base address register 911 to hold a base address for a configuration space to be associated with a function.

As a second example, cache 913 is provided. Cache 913 may hold a reference to configuration context (configuration space, a storage location for configuration context, or the configuration context itself) or it may act as a cache or buffer to support memory read/write semantics for device configuration.

As a specific example, cache storage 913 is to hold a reference to a configuration context for a device. Note from the discussion above, this may include a reference to a location of a configuration space, a location of a configuration context for a configuration space, a reference to a device/function for which a cached configuration context is associated with, the configuration context itself, or a combination thereof.

Additionally, in one embodiment, cache 913 is to support memory access semantics for configuration of devices/functions. Here, an access is made by a host device and buffered (or cached) in cache 913. Furthermore, control logic 912 is to service the access, e.g. provide the access to the appropriate location in the proper form, as well as potentially provide a completion to the host without a completion from the target device. This example, is further illustrated with quick reference to FIG. 10, where an embodiment of a protocol diagram for fast configuration of an element is illustrated.

Here, a memory access 1021, such as a write, to a memory address that is to target a configuration register in device 1015 is transmitted to controller 1010. Controller 1010 provides the write to device 1015 in an acceptable format, e.g. a write recognizable by device 1015 to update the associated configuration register with a new value from access 1021. In this scenario, cache 913 may be utilized to buffer the write. Additionally, controller 1010 provides a completion back to host 1005 in parallel (i.e. without a completion from device 1015 referencing write 1022 or at least partially at the same period of time in transit/processing as message 1022).

As can be seen in comparison to FIG. 8, the configuration of a register with device 1015 in FIG. 10 is accelerated from host 1005's perspective in that it quickly (and potentially immediately) receives a completion from controller 1010 without waiting for the delayed completion 824 in FIG. 8 that is in response to the completion of the write 822.

Returning to FIG. 9, reads of configuration space may also be accelerated. For example, a read access may be made by a host device. And if a current copy is held in cache 913, then the read can be serviced by the controller without going to memory or the device to obtain the current data value. As a result, in one embodiment the cache storage 913 is to be coherent with one or more processor caches. However, in another embodiment, cache storage 913 is not coherent with one or more processor caches. Yet, in some implementations, cache 913 is consistent with the configuration state of the associated device. As an example, cache 913, in some implementations, is implemented behind a bridge, where it is consistent with a device's configuration state but not coherent with a processor cache.

Any known other caching policies or algorithms may be utilized for control 912 and cache 913. As examples, control 911 and cache 913 may implement a write-through, write-back, or other known cache algorithm.

In one example where a cache is used to hold configuration values (either as a buffer for configuration accesses or holding configuration context) a controller and FCAM block 910 is capable to associate a memory address with a configuration register, receiving an access to the memory address, hold/store a configuration value for the register in cache 913, and to translate the memory access from the host processing device to the memory address into a configuration request for the configuration register in a first configuration mode, such as an Enhanced Configuration Access Mechanism mode). And the controller or a downstream component, such as a switch or bridge, is further capable to provide a configuration value held in cache 913 to the configuration register without a memory access from the host processing device in a second configuration mode, such as in a Fast Configuration Access Mode (FCAM). Note that in the FCAM mode a host processing device may perform a memory access that the controller caches and provides to the device, while providing an accelerated completion (as described above). However, in the FCAM mode that same memory access by the host processing device is not need to restore configuration context stored either in cache 913 or in another component.

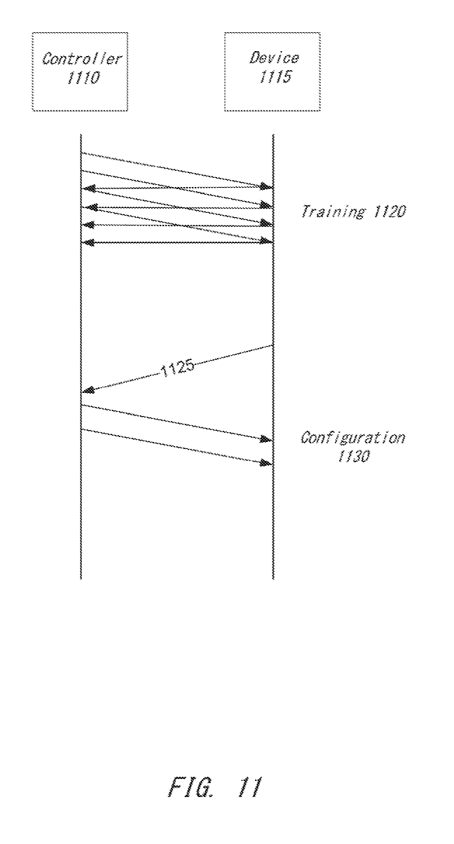

Turning to FIG. 11, an embodiment of a protocol diagram for a device to indicate fast configuration capability is depicted. As an example, a device may self-identify as FCAM capable. As illustrated, a link may perform some training 120, such as link training, or other phase/state transition. And device 1115 then sends message 1125 to indicate it is FCAM capable. As one example, message 1125 includes a DRS or DRSO-like message. As another example, message 1125 includes a configure base address register (CBAR) message to indicate a readiness for configuration, which may be in addition to or in place of a DRS message, that is to indicate a CBAR location. Upon receipt of message 1125, controller 1110 is then able to configure device 1115, sometimes without direct host intervention, using an FCAM or CBAR mechanism. In some instances, to support legacy compatibility, a root complex 1110 (or switch) may be precluded for an amount of time (e.g. a range of exemplary times include 1 ms to 500 ms and may be a specific value such as 100 ms) after a power event, such as a reset, from issuing configuration requests. However, if during the period of time, a DRS or CBAR message indicating FCAM capability is received, then configuration 1130 may start immediately without any further waiting.

Referring next to FIG. 12 an embodiment of a configuration space for an element in an interconnect architecture is illustrated. As shown, configuration region 1205, such as a configuration base address region or data structure therefore, includes legacy block 1210 and clean block 1215. Here, writes to the legacy block 1210 potentially include read/write byte selects interleaved with data as shown in the exemplary format for block 1210. As depicted a block 1210 format includes a header 1211, masks 122, and data 1213a-g, which as an example include double words. Furthermore, in one embodiment, writes to the legacy block 1210 are committed in increasing address order with side effects guaranteed to be appropriately processed.

Clean block 1215, in one embodiment, doesn't include read/write byte selects; although in an alternate embodiment it may. Bit definitions for clean block 1215 may defined in a manner that side effects are safe at the block level. Yet here, it may still be preferable to commit writes in increasing address order. In one embodiment, configuration logic in a controller and logic in the device are capable to support write combining and merging to clean block area 1215.

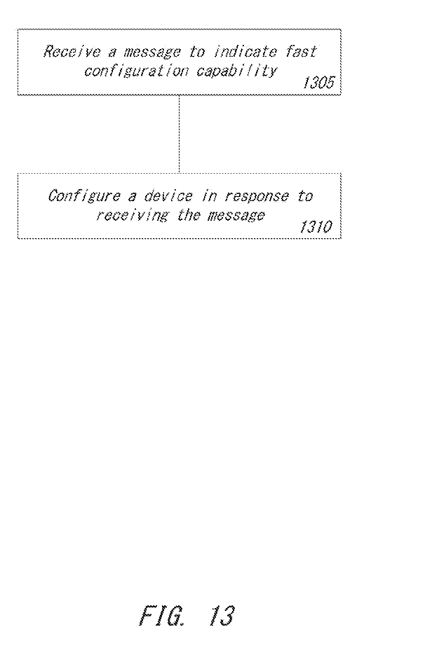

FIG. 13 illustrates an embodiment of a flow diagram for a method of configuring a device. Note from above that any of the protocol flows or operations performed by the logic described herein may be represented as a method. As an example, even though the discussion of FIG. 10 was in reference to a host, controller and device to transmit protocol messages. The message transmission (i.e. message 1021 and completion 1023 in response to message 1021 may be represented as a method as well). Conversely, any method described herein may be similarly implemented in an apparatus.

In the illustrated method of FIG. 13, a particular message from a device indicating fast configuration compatibility is received in flow 1305. As described above the message may include a DRS-like message or CBAR message. Here, a CBAR message may reference a location (i.e. a base address), which is used to update a CBAR in a controller. Then in flow 1310, a device is configured in response to receiving the message. In one embodiment, such configuration of a device is restoring a configuration context. Here, a FCAM capable message is received. And when the device is going to sleep it saves the configuration context to a structure like a cache. Then when is to enter an active power mode, a controller can directly configure the device based on the cached configuration context and the FCAM capability of the device. Or upon reset or power-on, a controller can configure the device immediately in response to receiving an FCAM capable message. Either way one or more configuration registers of an FCAM capable device may be updated or configured.

In one embodiment, configuring the device in flow 1310 comprises initiating a first memory write to the configuration address space and initiating a second memory write to a root complex memory space that is to be orthogonal to the configuration address space.

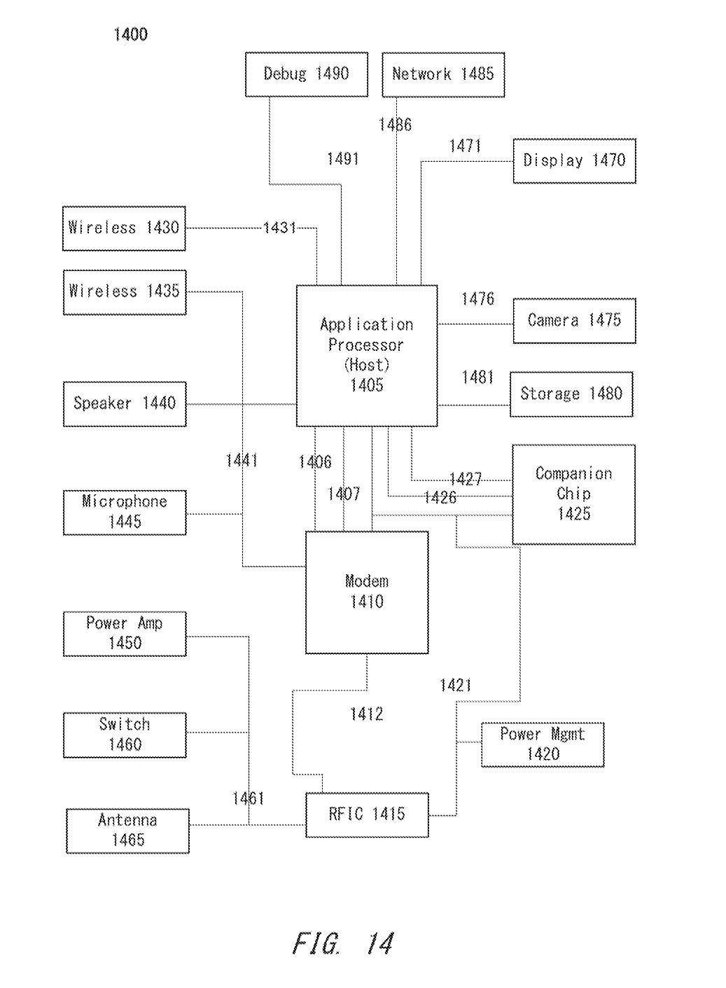

Referring to FIG. 14, an embodiment of a low power computing platform is depicted. In one embodiment, low power computing platform 1400 includes a user equipment (UE) or mobile terminal. A UE refers to, in some embodiments, a device that may be used to communicate, such as a device with voice communication capability. Examples of a UE includes a phone and a smart phone. However, a low power computing platform may also refer to any other platform to obtain a lower power operating point, such as a tablet, low power notebook, an ultraportable or ultrathin notebook, a micro-server server, a low power desktop, a transmitting device, a receiving device, or any other known or available computing platform that is not a mobile terminal. The illustrated platform depicts a number of different interconnects to couple multiple different devices. Exemplary discussion of these interconnect are provided below to provide options on implementation and inclusion of apparatus' and methods disclosed herein. For example, any of the illustrated and discussed interconnect protocols may implement a fast configuration mechanism similar to the discussion above in reference to the PCIe architecture, without potentially implementing the PCIe architecture itself. However, a low power platform 1400 is not required to include or implement the depicted interconnects or devices. Furthermore, other devices and interconnect structures that are not specifically shown may be included.

Starting at the center of the diagram, platform 1400 includes application processor 1405. Often this includes a low power processor, which may be a version of a processor configuration described herein or known in the industry. As one example, processor 1400 is implemented as a system on a chip (SoC). As a specific illustrative example, processor 1400 includes an Intel® Architecture Core™-based processor such as an i3, i5, i7 or another such processor available from Intel Corporation. Santa Clara, Calif. However, understand that other low power processors such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note as the processor and SoC technologies from these companies advance, more components illustrated as separate from host processor 1400 may be integrated on an SoC. As a result, similar interconnects (and inventions therein) may be used “on-die.”

In one embodiment, application processor 1405 runs an operating system, user interface and applications. Here, application processor 1405 often recognizes or is associated with an Instruction Set Architecture (ISA) that the operating system, user interface, and applications utilize to direct processor 1405's operation/execution. It also typically interfaces to sensors, cameras, displays, microphones and mass storage. Some implementations offload time critical telecom-related processing to other components.

As depicted, host processor 1405 is coupled to a wireless interface 1430, such as WLAN, WiGig, WirelessHD, or other wireless interface. Here an LLI, SSIC, or UniPort compliant interconnect is utilized to couple host processor 1405 and wireless interface 1430.

LLI stands for low latency interface. LLI typically enables memory sharing between two devices. A bidirectional interface transports memory transactions between two devices and allows a device to access the local memory of another device; often this is done without software intervention, as if it was a single device. LLI, in one embodiment, allows three classes of traffic, carrying signals over the link, reducing GPIO count. As an example, LLI defines a layered protocol stack for communication or a physical layer (PHY), such as an MPHY that is described in more detail below.

SSIC refers to SuperSpeed Inter-Chip. SSIC may enable the design of high speed USB devices using a low power physical layer. As an example, a MPHY layer is utilized, while USB 3.0 compliant protocols and software are utilized over the MPHY for better power performance.

UniPro describes a layered protocol stack with physical layer abstraction, providing a general purpose, error-handling, high speed solution for interconnecting a broad range of devices and components: application processors, co-processors, modems, and peripherals, as well as supporting different types of data traffic including control messages, bulk data transfer and packetized streaming. UniPro may support usage of an MPHY or DPHY.

Other interfaces may also couple directly to host processor 1405, such as debug 1490, Network 1485, Display 1470, camera 1475, and storage 1480 through other interfaces that may utilize the apparatus and methods described herein.

Debug interface 1490 and network 1485 communicates with application processor 1405 through a debug interface 1491, e.g. PTI, or network connection, e.g. a debug interface that operates over a functional network connection 1485.

Display 1470 includes one or more displays. In one embodiment, display 1470 includes a display with one or more touch sensors capable of receiving/sensing touch input. Here, display 1470 is coupled to application processor 1405 through display interface (DSI) 1471. DSI 1471 defines protocols between host processor and peripheral devices, which may utilize a D-PHY physical interface. It typically adopts pixel formats and a defined command set for video formats and signaling, such as Display Pixel Interface 2 (DPI-2), and control display module parameters, such as through a Display Command Set (DCS). As an example, DSI 1471 operates at approximately 1.5 Gb/s per lane or to 6 Gb/s.

Camera 1475, in one embodiment, includes an image sensor used for still pictures, video capture, or both. Front and back side cameras are common on mobile devices. Dual-cameras may be used to provide stereoscopic support. As depicted, cameral 1475 is coupled to application processor 1405 through a peripheral interconnect, such as CSI 1476. CSI 1476 defines an interface between a peripheral device (e.g. camera, Image Signal Processor) and a host processor (e.g. 1405, baseband, application engine). In one embodiment, image data transfers are performed over a DPHY, a unidirectional differential serial interface with data and clock signals. Control of the peripheral, in on embodiment, occurs over a separate back channel, such as camera control. As an illustrative example, the speed of CSI may range from 50 Mbps-2 Gbps, or any range/value therein.

Storage 1480, in one example, includes a non-volatile memory used by the application processor 1405 to store large amounts of information. It may be based on Flash technology or a magnetic type of storage, such as a hard-disk. Here, 1480 is coupled to processor 1405 through Universal Flash Storage (UFS) interconnect 1481. UFS 1481, in one embodiment, includes an interconnect that is tailored for low power computing platforms, such as mobile systems. As an example, it provides between 200 and 500 MB/s transfer rate (e.g. 300 MB/s) utilizing queuing features to increase random read/write speeds. In one implementations, UFS 1481 uses the MPHY physical layer and a protocol layer, such as UniPro.

Modem 1410 often stands for Modulator/demodulator. The modem 1410 typically provides the interface to the cellular network. It's capable of communicating with different networks types and different frequencies, depending on which communication standard is used. In one embodiment, both voice and data connections are supported. Modem 1410 is coupled to host 1405 utilizing any known interconnect, such as one or more of LLI, SSIC, UniPro, Mobile Express, etc.

In one embodiment, a control bus is utilized to couple control or data interfaces, such as wireless 1435, speaker 1440, microphone 1445. An example of such a bus is SLIMbus; a flexible low-power multi-drop interface capable of supporting a wide range of audio and control solutions. Other examples include PCM, I2S, I2C, SPI, and UART. Wireless 1435 includes an interface, such as a short range communication standard between two devices (e.g. Bluetooth or NFC), a navigation system capable of triangulating position and/or time (e.g. GPS), a receiver for analog or radio broadcasts (e.g FM Radio), or other known wireless interface or standard. Speaker(s) 1440 includes any device to generate sound, such as an electromechanical device to generate ringtones or music. Multiple speakers may be used for stereo or multi-channel sound. Microphone 1445 is often utilized for voice input, such as talking during a call.

Radio Frequency Integrated Circuit (RFIC) 1415 is to perform analog processing, such as processing of radio signals, e.g. amplification, mixing, filtering, and digital conversion. As depicted, RFIC 1415 is coupled to modem 1410 through interface 1412. In one embodiment, interface 1412 includes a bi-directional, high-speed interface (e.g. DigRF) that supports communication standards, such as LTE, 3GPP, EGPRS, UMTS, HSPA+, and TD-SCDMA. As a specific example, DigRF utilizes a frame-oriented protocol based on a M-PHY physical layer. DigRF is typically referred to as RF friendly, low latency, low power with optimized pin count that currently operations between 1.5 or 3 Gbps per lane and is configurable with multiple lanes, such as 4 lanes.

Interface 1461 (e.g. a RF control interface) includes a flexible bus to support simple to complex devices. As a specific example, interface 1461 includes a flexible two-wire serial bus, designed for control of RF Front-End components. One bus master may write and read to multiple devices, such as power amplifier 1450 to amplify the RF signal, sensors to receive sensor input, switch module(s) 1460 to switch between RF signal paths depending on a network mode, and antenna tuners 1465 to compensate for bad antenna conditions or enhancing bandwidth. Interface 1461, in one embodiment, has a group trigger function for timing-critical events and low EMI.

Power management 1420 is used to provide all the different components in the mobile device 1400 with power managed voltage, such as decreasing voltage or increasing it to improve efficiency for components in the mobile device. In one embodiment, it also controls and monitors the charge of the battery and remaining energy. A battery interface may be utilized between power management 1420 and the battery. As an illustrative example, the battery interface includes a single-wire communication between a mobile terminal and smart/low cost batteries.

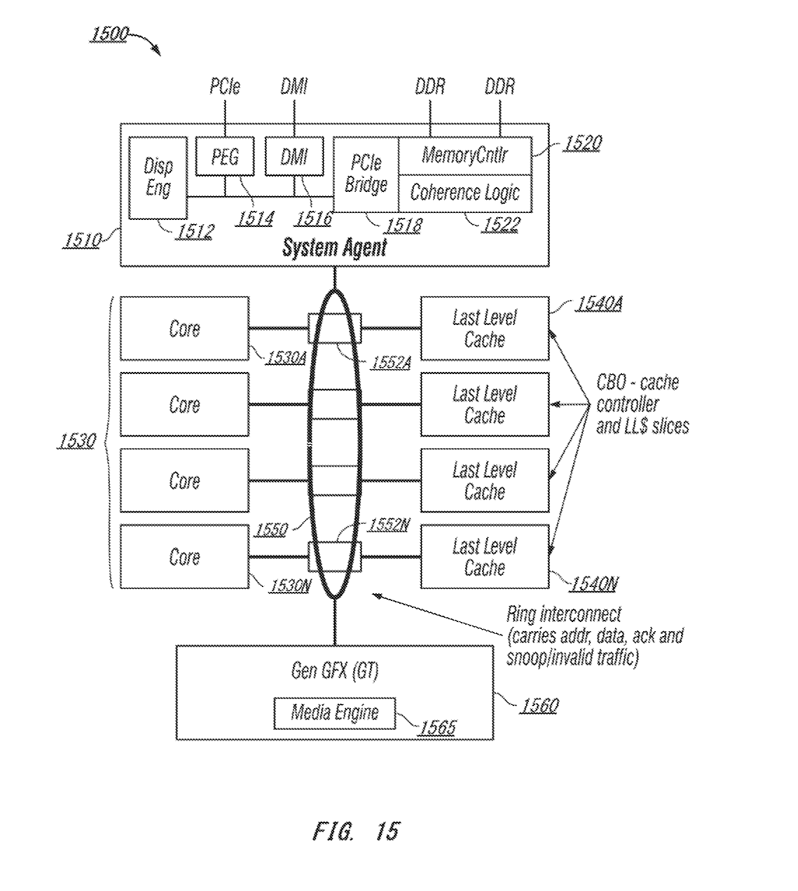

Referring now to FIG. 15, shown is a block diagram of an embodiment of a multicore processor. As shown in the embodiment of FIG. 15, processor 1500 includes multiple domains. Specifically, a core domain 1530 includes a plurality of cores 1530A-1530N, a graphics domain 1560 includes one or more graphics engines having a media engine 1565, and a system agent domain 1510. Here, a fast configuration mechanism as disclosed here may be implemented to configure an integrated device/function, such as graphics 1565 or other agent. Here, note that in some implementations, system agent 1510 may act as a root controller or complex, while cores 1530 include a host processing device.

In various embodiments, system agent domain 1510 handles power control events and power management, such that individual units of domains 1530 and 1560 (e.g. cores and/or graphics engines) are independently controllable to dynamically operate at an appropriate power mode/level (e.g. active, turbo, sleep, hibernate, deep sleep, or other Advanced Configuration Power Interface like state) in light of the activity (or inactivity) occurring in the given unit. Each of domains 1530 and 1560 may operate at different voltage and/or power, and furthermore the individual units within the domains each potentially operate at an independent frequency and voltage. Note that while only shown with three domains, understand the scope of the present invention is not limited in this regard and additional domains may be present in other embodiments.

As shown, each core 1530 further includes low level caches in addition to various execution units and additional processing elements. Here, the various cores are coupled to each other and to a shared cache memory that is formed of a plurality of units or slices of a last level cache (LLC) 1540A-1540N; these LLCs often include storage and cache controller functionality and are shared amongst the cores, as well as potentially among the graphics engine too.

As seen, a ring interconnect 1550 couples the cores together, and provides interconnection between the core domain 1530, graphics domain 1560 and system agent circuitry 1510, via a plurality of ring stops 1552A-1552N, each at a coupling between a core and LLC slice. As seen in FIG. 15, interconnect 1550 is used to carry various information, including address information, data information, acknowledgement information, and snoop/invalid information. Although a ring interconnect is illustrated, any known on-die interconnect or fabric may be utilized. As an illustrative example, some of the fabrics discussed above (e.g. another on-die interconnect, Intel On-chip System Fabric (IOSF), an Advanced Microcontroller Bus Architecture (AMBA) interconnect, a multi-dimensional mesh fabric, or other known interconnect architecture) may be utilized in a similar fashion.

As further depicted, system agent domain 1510 includes display engine 1512 which is to provide control of and an interface to an associated display. System agent domain 1510 may include other units, such as: an integrated memory controller 1520 that provides for an interface to a system memory (e.g., a DRAM implemented with multiple DIMMs; coherence logic 1522 to perform memory coherence operations. Multiple interfaces may be present to enable interconnection between the processor and other circuitry. For example, in one embodiment at least one direct media interface (DMI) 1516 interface is provided as well as one or more PCIe interfaces 1514. The display engine and these interfaces typically couple to memory via a PCIe bridge 1518. Still further, to provide for communications between other agents, such as additional processors or other circuitry, one or more other interfaces (e.g. an Intel® Quick Path Interconnect (QPI) fabric) may be provided.

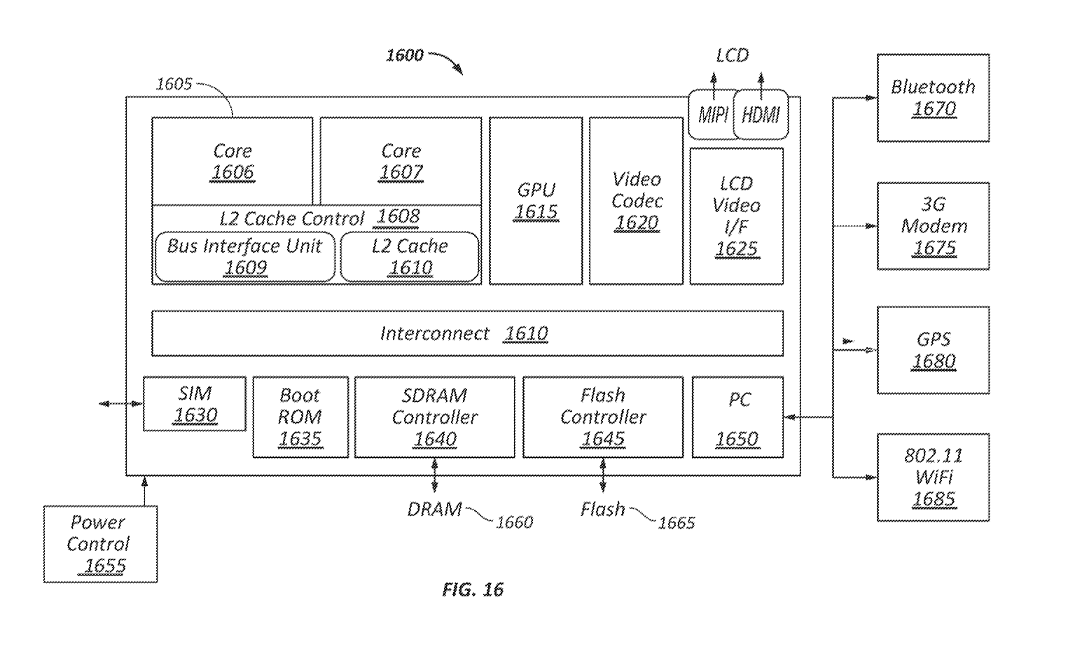

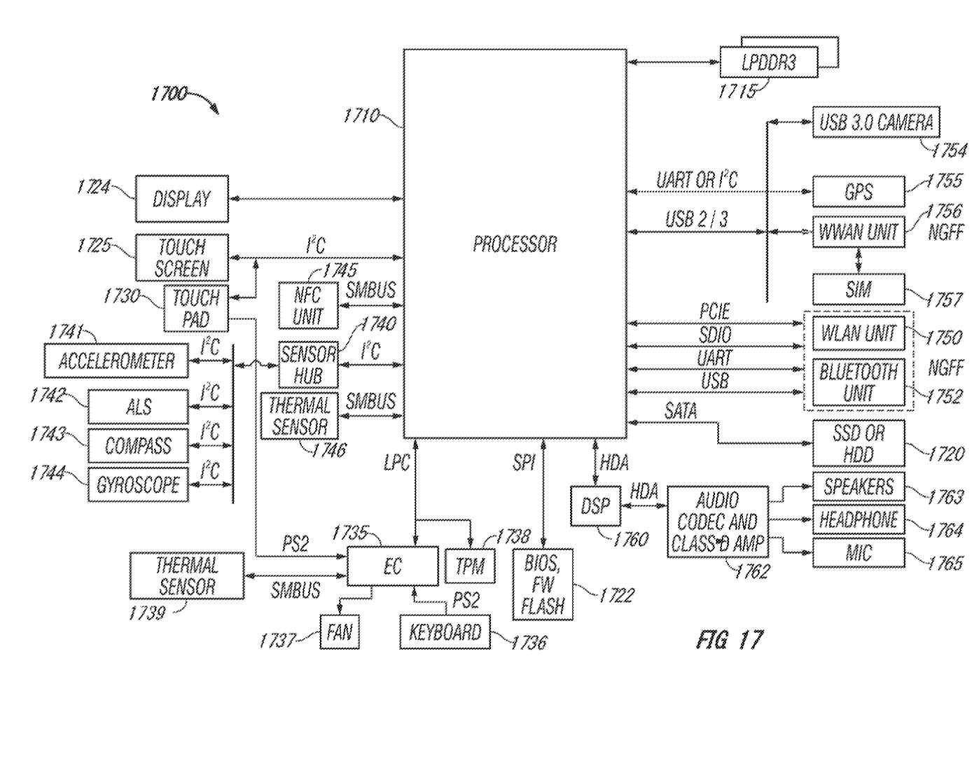

Turning next to FIG. 16, an embodiment of a system on-chip (SOC) design in accordance with the inventions is depicted. As a specific illustrative example, SOC 1600 is included in user equipment (UE) or a mobile terminal. In one embodiment, UE refers to any device to be used by an end-user to communicate, such as a hand-held phone. Often a UE connects to a base station or node, which potentially corresponds in nature to a mobile station (MS) in a GSM network. However, the depicted SoC may be utilized in other non-mobile terminals, such as a tablet, ultra-thin notebook, notebook with broadband adapter, or any other similar communication device. Within SoC 1600, a fast configuration mechanism may be utilized as described herein to configure integrated devices, such as GPU 1615, Video 1620, Video 1625, Flash controller 1645, SDRAm controller 1640, Boot ROM 1635, SIM 1630, power control 1655, PC 1650, or other block of logic. Here, a controller or other logic in block 1610 may operate as a root complex. Furthermore, the fast configuration mechanism may be utilized to configure devices coupled the illustrated MIPI, HDMI, or other non-illustrated ports.

Here, SOC 1600 includes 2 cores—1606 and 1607. Similar to the discussion above, cores 1606 and 1607 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1606 and 1607 are coupled to cache control 1608 that is associated with bus interface unit 1609 and L2 cache 1610 to communicate with other parts of system 1600. Interconnect 1610 includes an on-chip interconnect, such as an IOSF, AMBA, or other interconnect discussed above, which potentially implements one or more aspects of the described invention.

Interface 1610 provides communication channels to the other components, such as a Subscriber Identity Module (SIM) 1630 to interface with a SIM card, a boot rom 1635 to hold boot code for execution by cores 1606 and 1607 to initialize and boot SOC 1600, a SDRAM controller 1640 to interface with external memory (e.g. DRAM 1660), a flash controller 1645 to interface with non-volatile memory (e.g. Flash 1665), a peripheral control Q1650 (e.g. Serial Peripheral Interface) to interface with peripherals, video codecs 1620 and Video interface 1625 to display and receive input (e.g. touch enabled input), GPU 1615 to perform graphics related computations, etc. Any of these interfaces may incorporate aspects of the invention described herein.

In addition, the system illustrates peripherals for communication, such as a Bluetooth module 1670, 3G modem 1675, GPS 1685, and WiFi 1685. Note as stated above, a UE includes a radio for communication. As a result, these peripheral communication modules are not all required. However, in a UE some form a radio for external communication is to be included.

Note that the apparatus', methods', and systems described above may be implemented in any electronic device or system as aforementioned. As specific illustrations, the figures below provide exemplary systems for utilizing the invention as described herein. As the systems below are described in more detail, a number of different interconnects are disclosed, described, and revisited from the discussion above. And as is readily apparent, the advances described above may be applied to any of those interconnects, fabrics, or architectures.

Referring now to FIG. 17, a block diagram of components present in a computer system in accordance with an embodiment of the present invention is illustrated. Similar to the discussion above, a fast configuration mechanism may be utilized on processor 1710 or coupled thereto to configure any of the blocks shown/described in FIG. 17. As depicted, system 1700 includes any combination of components. These components may be implemented as ICs, portions thereof, discrete electronic devices, or other modules, logic, hardware, software, firmware, or a combination thereof adapted in a computer system, or as components otherwise incorporated within a chassis of the computer system. Note also that the block diagram of FIG. 17 is intended to show a high level view of many components of the computer system. However, it is to be understood that some of the components shown may be omitted, additional components may be present, and different arrangement of the components shown may occur in other implementations. As a result, the invention described above may be implemented in any portion of one or more of the interconnects illustrated or described below.

As seen in FIG. 17, a processor 1710, in one embodiment, includes a microprocessor, multi-core processor, multithreaded processor, an ultra low voltage processor, an embedded processor, or other known processing element. In the illustrated implementation, processor 1710 acts as a main processing unit and central hub for communication with many of the various components of the system 1700. As one example, processor 1700 is implemented as a system on a chip (SoC). As a specific illustrative example, processor 1710 includes an Intel® Architecture Core™-based processor such as an i3, i5, i7 or another such processor available from Intel Corporation, Santa Clara, Calif. However, understand that other low power processors such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note that many of the customer versions of such processors are modified and varied; however, they may support or recognize a specific instructions set that performs defined algorithms as set forth by the processor licensor. Here, the microarchitectural implementation may vary, but the architectural function of the processor is usually consistent. Certain details regarding the architecture and operation of processor 1710 in one implementation will be discussed further below to provide an illustrative example.

Processor 1710, in one embodiment, communicates with a system memory 1715. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (Q17P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage 1720 may also couple to processor 1710. In various embodiments, to enable a thinner and lighter system design as well as to improve system responsiveness, this mass storage may be implemented via a SSD. However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also shown in FIG. 17, a flash device 1722 may be coupled to processor 1710. e.g., via a serial peripheral interface (SPI). This flash device may provide for non-volatile storage of system software, including a basic input/output software (BIOS) as well as other firmware of the system.

In various embodiments, mass storage of the system is implemented by a SSD alone or as a disk, optical or other drive with an SSD cache. In some embodiments, the mass storage is implemented as a SSD or as a HDD along with a restore (RST) cache module. In various implementations, the HDD provides for storage of between 320 GB-4 terabytes (TB) and upward while the RST cache is implemented with a SSD having a capacity of 24 GB-256 GB. Note that such SSD cache may be configured as a single level cache (SLC) or multi-level cache (MLC) option to provide an appropriate level of responsiveness. In a SSD-only option, the module may be accommodated in various locations such as in a mSATA or NGFF slot. As an example, an SSD has a capacity ranging from 120 GB-1 TB.

Various input/output (IO) devices may be present within system 1700. Specifically shown in the embodiment of FIG. 17 is a display 1724 which may be a high definition LCD or LED panel configured within a lid portion of the chassis. This display panel may also provide for a touch screen 1725, e.g., adapted externally over the display panel such that via a user's interaction with this touch screen, user inputs can be provided to the system to enable desired operations, e.g., with regard to the display of information, accessing of information and so forth. In one embodiment, display 1724 may be coupled to processor 1710 via a display interconnect that can be implemented as a high performance graphics interconnect. Touch screen 1725 may be coupled to processor 1710 via another interconnect, which in an embodiment can be an I²C interconnect. As further shown in FIG. 17, in addition to touch screen 1725, user input by way of touch can also occur via a touch pad 1730 which may be configured within the chassis and may also be coupled to the same I²C interconnect as touch screen 1725.

The display panel may operate in multiple modes. In a first mode, the display panel can be arranged in a transparent state in which the display panel is transparent to visible light. In various embodiments, the majority of the display panel may be a display except for a bezel around the periphery. When the system is operated in a notebook mode and the display panel is operated in a transparent state, a user may view information that is presented on the display panel while also being able to view objects behind the display. In addition, information displayed on the display panel may be viewed by a user positioned behind the display. Or the operating state of the display panel can be an opaque state in which visible light does not transmit through the display panel.

In a tablet mode the system is folded shut such that the back display surface of the display panel comes to rest in a position such that it faces outwardly towards a user, when the bottom surface of the base panel is rested on a surface or held by the user. In the tablet mode of operation, the back display surface performs the role of a display and user interface, as this surface may have touch screen functionality and may perform other known functions of a conventional touch screen device, such as a tablet device. To this end, the display panel may include a transparency-adjusting layer that is disposed between a touch screen layer and a front display surface. In some embodiments the transparency-adjusting layer may be an electrochromic layer (EC), a LCD layer, or a combination of EC and LCD layers.

In various embodiments, the display can be of different sizes, e.g., an 11.6″ or a 13.3″ screen, and may have a 16:9 aspect ratio, and at least 300 nits brightness. Also the display may be of full high definition (HD) resolution (at least 1920×1080 p), be compatible with an embedded display port (eDP), and be a low power panel with panel self refresh.

As to touch screen capabilities, the system may provide for a display multi-touch panel that is multi-touch capacitive and being at least 5 finger capable. And in some embodiments, the display may be 10 finger capable. In one embodiment, the touch screen is accommodated within a damage and scratch-resistant glass and coating (e.g., Gorilla Glass™ or Gorilla Glass 2™) for low friction to reduce “finger burn” and avoid “finger skipping”. To provide for an enhanced touch experience and responsiveness, the touch panel, in some implementations, has multi-touch functionality, such as less than 2 frames (30 Hz) per static view during pinch zoom, and single-touch functionality of less than 1 cm per frame (30 Hz) with 200 ms (lag on finger to pointer). The display, in some implementations, supports edge-to-edge glass with a minimal screen bezel that is also flush with the panel surface, and limited IO interference when using multi-touch.

For perceptual computing and other purposes, various sensors may be present within the system and may be coupled to processor 1710 in different manners. Certain inertial and environmental sensors may couple to processor 1710 through a sensor hub 1740, e.g., via an I²C interconnect. In the embodiment shown in FIG. 17, these sensors may include an accelerometer 1741, an ambient light sensor (ALS) 1742, a compass 1743 and a gyroscope 1744. Other environmental sensors may include one or more thermal sensors 1746 which in some embodiments couple to processor 1710 via a system management bus (SMBus) bus.

Using the various inertial and environmental sensors present in a platform, many different use cases may be realized. These use cases enable advanced computing operations including perceptual computing and also allow for enhancements with regard to power management/battery life, security, and system responsiveness.

For example with regard to power management/battery life issues, based at least on part on information from an ambient light sensor, the ambient light conditions in a location of the platform are determined and intensity of the display controlled accordingly. Thus, power consumed in operating the display is reduced in certain light conditions.

As to security operations, based on context information obtained from the sensors such as location information, it may be determined whether a user is allowed to access certain secure documents. For example, a user may be permitted to access such documents at a work place or a home location. However, the user is prevented from accessing such documents when the platform is present at a public location. This determination, in one embodiment, is based on location information, e.g., determined via a GPS sensor or camera recognition of landmarks. Other security operations may include providing for pairing of devices within a close range of each other, e.g., a portable platform as described herein and a user's desktop computer, mobile telephone or so forth. Certain sharing, in some implementations, are realized via near field communication when these devices are so paired. However, when the devices exceed a certain range, such sharing may be disabled. Furthermore, when pairing a platform as described herein and a smartphone, an alarm may be configured to be triggered when the devices move more than a predetermined distance from each other, when in a public location. In contrast, when these paired devices are in a safe location, e.g., a work place or home location, the devices may exceed this predetermined limit without triggering such alarm.

Responsiveness may also be enhanced using the sensor information. For example, even when a platform is in a low power state, the sensors may still be enabled to run at a relatively low frequency. Accordingly, any changes in a location of the platform, e.g., as determined by inertial sensors, GPS sensor, or so forth is determined. If no such changes have been registered, a faster connection to a previous wireless hub such as a Wi-Fi™ access point or similar wireless enabler occurs, as there is no need to scan for available wireless network resources in this case. Thus, a greater level of responsiveness when waking from a low power state is achieved.

It is to be understood that many other use cases may be enabled using sensor information obtained via the integrated sensors within a platform as described herein, and the above examples are only for purposes of illustration. Using a system as described herein, a perceptual computing system may allow for the addition of alternative input modalities, including gesture recognition, and enable the system to sense user operations and intent.

In some embodiments one or more infrared or other heat sensing elements, or any other element for sensing the presence or movement of a user may be present. Such sensing elements may include multiple different elements working together, working in sequence, or both. For example, sensing elements include elements that provide initial sensing, such as light or sound projection, followed by sensing for gesture detection by, for example, an ultrasonic time of flight camera or a patterned light camera.

Also in some embodiments, the system includes a light generator to produce an illuminated line. In some embodiments, this line provides a visual cue regarding a virtual boundary, namely an imaginary or virtual location in space, where action of the user to pass or break through the virtual boundary or plane is interpreted as an intent to engage with the computing system. In some embodiments, the illuminated line may change colors as the computing system transitions into different states with regard to the user. The illuminated line may be used to provide a visual cue for the user of a virtual boundary in space, and may be used by the system to determine transitions in state of the computer with regard to the user, including determining when the user wishes to engage with the computer.

In some embodiments, the computer senses user position and operates to interpret the movement of a hand of the user through the virtual boundary as a gesture indicating an intention of the user to engage with the computer. In some embodiments, upon the user passing through the virtual line or plane the light generated by the light generator may change, thereby providing visual feedback to the user that the user has entered an area for providing gestures to provide input to the computer.

Display screens may provide visual indications of transitions of state of the computing system with regard to a user. In some embodiments, a first screen is provided in a first state in which the presence of a user is sensed by the system, such as through use of one or more of the sensing elements.

In some implementations, the system acts to sense user identity, such as by facial recognition. Here, transition to a second screen may be provided in a second state, in which the computing system has recognized the user identity, where this second the screen provides visual feedback to the user that the user has transitioned into a new state. Transition to a third screen may occur in a third state in which the user has confirmed recognition of the user.

In some embodiments, the computing system may use a transition mechanism to determine a location of a virtual boundary for a user, where the location of the virtual boundary may vary with user and context. The computing system may generate a light, such as an illuminated line, to indicate the virtual boundary for engaging with the system. In some embodiments, the computing system may be in a waiting state, and the light may be produced in a first color. The computing system may detect whether the user has reached past the virtual boundary, such as by sensing the presence and movement of the user using sensing elements.

In some embodiments, if the user has been detected as having crossed the virtual boundary (such as the hands of the user being closer to the computing system than the virtual boundary line), the computing system may transition to a state for receiving gesture inputs from the user, where a mechanism to indicate the transition may include the light indicating the virtual boundary changing to a second color.

In some embodiments, the computing system may then determine whether gesture movement is detected. If gesture movement is detected, the computing system may proceed with a gesture recognition process, which may include the use of data from a gesture data library, which may reside in memory in the computing device or may be otherwise accessed by the computing device.

If a gesture of the user is recognized, the computing system may perform a function in response to the input, and return to receive additional gestures if the user is within the virtual boundary. In some embodiments, if the gesture is not recognized, the computing system may transition into an error state, where a mechanism to indicate the error state may include the light indicating the virtual boundary changing to a third color, with the system returning to receive additional gestures if the user is within the virtual boundary for engaging with the computing system.

As mentioned above, in other embodiments the system can be configured as a convertible tablet system that can be used in at least two different modes, a tablet mode and a notebook mode. The convertible system may have two panels, namely a display panel and a base panel such that in the tablet mode the two panels are disposed in a stack on top of one another. In the tablet mode, the display panel faces outwardly and may provide touch screen functionality as found in conventional tablets. In the notebook mode, the two panels may be arranged in an open clamshell configuration.

In various embodiments, the accelerometer may be a 3-axis accelerometer having data rates of at least 50 Hz. A gyroscope may also be included, which can be a 3-axis gyroscope. In addition, an e-compass/magnetometer may be present. Also, one or more proximity sensors may be provided (e.g., for lid open to sense when a person is in proximity (or not) to the system and adjust power/performance to extend battery life). For some OS's Sensor Fusion capability including the accelerometer, gyroscope, and compass may provide enhanced features. In addition, via a sensor hub having a real-time clock (RTC), a wake from sensors mechanism may be realized to receive sensor input when a remainder of the system is in a low power state.

In some embodiments, an internal lid/display open switch or sensor to indicate when the lid is closed/open, and can be used to place the system into Connected Standby or automatically wake from Connected Standby state. Other system sensors can include ACPI sensors for internal processor, memory, and skin temperature monitoring to enable changes to processor and system operating states based on sensed parameters.

In an embodiment, the OS may be a Microsoft® Windows® 8 OS that implements Connected Standby (also referred to herein as Win8 CS). Windows 8 Connected Standby or another OS having a similar state can provide, via a platform as described herein, very low ultra idle power to enable applications to remain connected, e.g., to a cloud-based location, at very low power consumption. The platform can supports 3 power states, namely screen on (normal); Connected Standby (as a default “off” state); and shutdown (zero watts of power consumption). Thus in the Connected Standby state, the platform is logically on (at minimal power levels) even though the screen is off. In such a platform, power management can be made to be transparent to applications and maintain constant connectivity, in part due to offload technology to enable the lowest powered component to perform an operation.

Also seen in FIG. 17, various peripheral devices may couple to processor 1710 via a low pin count (LPC) interconnect. In the embodiment shown, various components can be coupled through an embedded controller 1735. Such components can include a keyboard 1736 (e.g., coupled via a PS2 interface), a fan 1737, and a thermal sensor 1739. In some embodiments, touch pad 1730 may also couple to EC 1735 via a PS2 interface. In addition, a security processor such as a trusted platform module (TPM) 1738 in accordance with the Trusted Computing Group (TCG) TPM Specification Version 1.2, dated Oct. 2, 2003, may also couple to processor 1710 via this LPC interconnect. However, understand the scope of the present invention is not limited in this regard and secure processing and storage of secure information may be in another protected location such as a static random access memory (SRAM) in a security coprocessor, or as encrypted data blobs that are only decrypted when protected by a secure enclave (SE) processor mode.

In a particular implementation, peripheral ports may include a high definition media interface (HDMI) connector (which can be of different form factors such as full size, mini or micro); one or more USB ports, such as full-size external ports in accordance with the Universal Serial Bus Revision 3.0 Specification (November 2008), with at least one powered for charging of USB devices (such as smartphones) when the system is in Connected Standby state and is plugged into AC wall power. In addition, one or more Thunderbolt™ ports can be provided. Other ports may include an externally accessible card reader such as a full size SD-XC card reader and/or a SIM card reader for WWAN (e.g., an 8 pin card reader). For audio, a 3.5 mm jack with stereo sound and microphone capability (e.g., combination functionality) can be present, with support for jack detection (e.g., headphone only support using microphone in the lid or headphone with microphone in cable). In some embodiments, this jack can be re-taskable between stereo headphone and stereo microphone input. Also, a power jack can be provided for coupling to an AC brick.

System 1700 can communicate with external devices in a variety of manners, including wirelessly. In the embodiment shown in FIG. 17, various wireless modules, each of which can correspond to a radio configured for a particular wireless communication protocol, are present. One manner for wireless communication in a short range such as a near field may be via a near field communication (NFC) unit 1745 which may communicate, in one embodiment with processor 1710 via an SMBus. Note that via this NFC unit 1745, devices in close proximity to each other can communicate. For example, a user can enable system 1700 to communicate with another (e.g.,) portable device such as a smartphone of the user via adapting the two devices together in close relation and enabling transfer of information such as identification information payment information, data such as image data or so forth. Wireless power transfer may also be performed using a NFC system.

Using the NFC unit described herein, users can bump devices side-to-side and place devices side-by-side for near field coupling functions (such as near field communication and wireless power transfer (WPT)) by leveraging the coupling between coils of one or more of such devices. More specifically, embodiments provide devices with strategically shaped, and placed, ferrite materials, to provide for better coupling of the coils. Each coil has an inductance associated with it, which can be chosen in conjunction with the resistive, capacitive, and other features of the system to enable a common resonant frequency for the system.

As further seen in FIG. 17, additional wireless units can include other short range wireless engines including a WLAN unit 1750 and a Bluetooth unit 1752. Using WLAN unit 1750, Wi-Fi™ communications in accordance with a given Institute of Electrical and Electronics Engineers (IEEE) 802.11 standard can be realized, while via Bluetooth unit 1752, short range communications via a Bluetooth protocol can occur. These units may communicate with processor 1710 via, e.g., a USB link or a universal asynchronous receiver transmitter (UART) link. Or these units may couple to processor 1710 via an interconnect according to a Peripheral Component Interconnect Express™ (PCIe™) protocol, e.g., in accordance with the PCI Express™ Specification Base Specification version 3.0 (published Jan. 17, 2007), or another such protocol such as a serial data input/output (SDIO) standard. Of course, the actual physical connection between these peripheral devices, which may be configured on one or more add-in cards, can be by way of the NGFF connectors adapted to a motherboard.

In addition, wireless wide area communications, e.g., according to a cellular or other wireless wide area protocol, can occur via a WWAN unit 1756 which in turn may couple to a subscriber identity module (SIM) 1757. In addition, to enable receipt and use of location information, a GPS module 1755 may also be present. Note that in the embodiment shown in FIG. 17, WWAN unit 1756 and an integrated capture device such as a camera module 1754 may communicate via a given USB protocol such as a USB 2.0 or 3.0 link, or a UART or I²C protocol. Again the actual physical connection of these units can be via adaptation of a NGFF add-in card to an NGFF connector configured on the motherboard.

In a particular embodiment, wireless functionality can be provided modularly, e.g., with a WiFi™ 802.11ac solution (e.g., add-in card that is backward compatible with IEEE 802.11abgn) with support for Windows 8 CS. This card can be configured in an internal slot (e.g., via an NGFF adapter). An additional module may provide for Bluetooth capability (e.g., Bluetooth 4.0 with backwards compatibility) as well as Intel® Wireless Display functionality. In addition NFC support may be provided via a separate device or multi-function device, and can be positioned as an example, in a front right portion of the chassis for easy access. A still additional module may be a WWAN device that can provide support for 3G/4G/LTE and GPS. This module can be implemented in an internal (e.g., NGFF) slot. Integrated antenna support can be provided for WiFi™, Bluetooth, WWAN, NFC and GPS, enabling seamless transition from WiFi™ to WWAN radios, wireless gigabit (WiGig) in accordance with the Wireless Gigabit Specification (July 2010), and vice versa.

As described above, an integrated camera can be incorporated in the lid. As one example, this camera can be a high resolution camera, e.g., having a resolution of at least 2.0 megapixels (MP) and extending to 6.0 MP and beyond.

To provide for audio inputs and outputs, an audio processor can be implemented via a digital signal processor (DSP) 1760, which may couple to processor 1710 via a high definition audio (HDA) link. Similarly, DSP 1760 may communicate with an integrated coder/decoder (CODEC) and amplifier 1762 that in turn may couple to output speakers 1763 which may be implemented within the chassis. Similarly, amplifier and CODEC 1762 can be coupled to receive audio inputs from a microphone 1765 which in an embodiment can be implemented via dual array microphones (such as a digital microphone array) to provide for high quality audio inputs to enable voice-activated control of various operations within the system. Note also that audio outputs can be provided from amplifier/CODEC 1762 to a headphone jack 1764. Although shown with these particular components in the embodiment of FIG. 17, understand the scope of the present invention is not limited in this regard.

In a particular embodiment, the digital audio codec and amplifier are capable of driving the stereo headphone jack, stereo microphone jack, an internal microphone array and stereo speakers. In different implementations, the codec can be integrated into an audio DSP or coupled via an HD audio path to a peripheral controller hub (PCH). In some implementations, in addition to integrated stereo speakers, one or more bass speakers can be provided, and the speaker solution can support DTS audio.

In some embodiments, processor 1710 may be powered by an external voltage regulator (VR) and multiple internal voltage regulators that are integrated inside the processor die, referred to as fully integrated voltage regulators (FIVRs). The use of multiple FIVRs in the processor enables the grouping of components into separate power planes, such that power is regulated and supplied by the FIVR to only those components in the group. During power management, a given power plane of one FIVR may be powered down or off when the processor is placed into a certain low power state, while another power plane of another FIVR remains active, or fully powered.

In one embodiment, a sustain power plane can be used during some deep sleep states to power on the L/O pins for several I/O signals, such as the interface between the processor and a PCH, the interface with the external VR and the interface with EC 1735. This sustain power plane also powers an on-die voltage regulator that supports the on-board SRAM or other cache memory in which the processor context is stored during the sleep state. The sustain power plane is also used to power on the processor's wakeup logic that monitors and processes the various wakeup source signals.

During power management, while other power planes are powered down or off when the processor enters certain deep sleep states, the sustain power plane remains powered on to support the above-referenced components. However, this can lead to unnecessary power consumption or dissipation when those components are not needed. To this end, embodiments may provide a connected standby sleep state to maintain processor context using a dedicated power plane. In one embodiment, the connected standby sleep state facilitates processor wakeup using resources of a PCH which itself may be present in a package with the processor. In one embodiment, the connected standby sleep state facilitates sustaining processor architectural functions in the PCH until processor wakeup, this enabling turning off all of the unnecessary processor components that were previously left powered on during deep sleep states, including turning off all of the clocks. In one embodiment, the PCH contains a time stamp counter (TSC) and connected standby logic for controlling the system during the connected standby state. The integrated voltage regulator for the sustain power plane may reside on the PCH as well.

In an embodiment, during the connected standby state, an integrated voltage regulator may function as a dedicated power plane that remains powered on to support the dedicated cache memory in which the processor context is stored such as critical state variables when the processor enters the deep sleep states and connected standby state. This critical state may include state variables associated with the architectural, micro-architectural, debug state, and/or similar state variables associated with the processor.

The wakeup source signals from EC 1735 may be sent to the PCH instead of the processor during the connected standby state so that the PCH can manage the wakeup processing instead of the processor. In addition, the TSC is maintained in the PCH to facilitate sustaining processor architectural functions. Although shown with these particular components in the embodiment of FIG. 17, understand the scope of the present invention is not limited in this regard.

Power control in the processor can lead to enhanced power savings. For example, power can be dynamically allocate between cores, individual cores can change frequency/voltage, and multiple deep low power states can be provided to enable very low power consumption. In addition, dynamic control of the cores or independent core portions can provide for reduced power consumption by powering off components when they are not being used.

Some implementations may provide a specific power management IC (PMIC) to control platform power. Using this solution, a system may see very low (e.g., less than 5%) battery degradation over an extended duration (e.g., 16 hours) when in a given standby state, such as when in a Win8 Connected Standby state. In a Win8 idle state a battery life exceeding, e.g., 9 hours may be realized (e.g., at 150 nits). As to video playback, a long battery life can be realized, e.g., full HD video playback can occur for a minimum of 6 hours. A platform in one implementation may have an energy capacity of, e.g., 35 watt hours (Whr) for a Win8 CS using an SSD and (e.g.,) 40-44 Whr for Win8 CS using an HDD with a RST cache configuration.

A particular implementation may provide support for 15 W nominal CPU thermal design power (TDP), with a configurable CPU TDP of up to approximately 25 W TDP design point. The platform may include minimal vents owing to the thermal features described above. In addition, the platform is pillow-friendly (in that no hot air is blowing at the user). Different maximum temperature points can be realized depending on the chassis material. In one implementation of a plastic chassis (at least having to lid or base portion of plastic), the maximum operating temperature can be 52 degrees Celsius (C). And for an implementation of a metal chassis, the maximum operating temperature can be 46° C.

In different implementations, a security module such as a TPM can be integrated into a processor or can be a discrete device such as a TPM 2.0 device. With an integrated security module, also referred to as Platform Trust Technology (PTT), BIOS/firmware can be enabled to expose certain hardware features for certain security features, including secure instructions, secure boot, Intel® Anti-Theft Technology, Intel® Identity Protection Technology, Intel® Trusted Execution Technology (TXT), and Intel® Manageability Engine Technology along with secure user interfaces such as a secure keyboard and display.

Numerous examples are provided below. Note that these are purely exemplary. Furthermore, some refer to apparatus, methods, computer-readable medium, means, etc. However, any of the examples may be provided for or interchanged. For example, one of the illustrations provides for a computer readable medium having code, when executed, to perform certain items. Those items may similarly viewed as a items of a method or logic in an apparatus to perform those items.

In one example, An apparatus for device configuration comprising: interface logic to be coupled to an element; configuration storage to hold a reference to a configuration context to be associated with the element; and configuration control logic coupled to the configuration storage and the second interface, the configuration control logic to configure at least part of the configuration context to be associated with the element, in response to a power event, based on the reference to the configuration context to be held in the configuration storage.

In one example, the interface logic includes physical layer logic based on a physical layer (PHY) specification selected from a group consisting of a low power PHY specification, a mobile industry peripheral interface (MIPI) specification, a peripheral component interconnect express (PCIe) specification, and a higher performance and power PHY specification.

In one example, the element comprises a peripheral component interconnect express (PCIe) device capable of recognizing a plurality of PCIe specification defined protocol communications.

In one example, the configuration context comprises state for a plurality of configuration space parameters for the element.

In one example, the configuration storage to hold a reference to a configuration context comprises an address register to hold an address reference to a memory mapped configuration space to be associated with the element.

In one example, the apparatus comprises a root controller, and wherein the configuration storage comprises cache storage to hold the reference to the configuration context and the configuration context.

In one example, the cache storage is to be coherent with one or more processor caches to be included in a processor to be coupled to the root controller.

In one example, the cache storage is not to be coherent with one or more processor caches to be included in a processor to be coupled to the root controller.

In one example, the cache storage is to implement a write-through policy.

In one example, the configuration control logic to configure at least part of the configuration context in response to a power event if further without intervention from a host device to configure the element.

In one example, the power event comprises an indication that the element is to enter an active power state.

In one example, the power event comprises an indication that the element is to complete link training.

In one example, the interface logic, configuration storage, and configuration control logic are integrated on a system on a chip (SoC) coupled to wireless interface logic capable of voice communication.

In one example, the interface logic, configuration storage, and configuration control logic are integrated on an integrated circuit that is coupled in a non-mobile terminal system.

In one example, An apparatus for device configuration comprising: a host processing device; storage; an integrated device to write configuration data for the integrated device to the storage and to enter a low power state subsequent to the write of configuration data to the storage; and a controller coupled to the host processing device, the integrated device, and the storage, the controller to configure the integrated device without direct intervention of the host processing device based at least in part on the configuration data to be held in the storage in response to the integrated device initiating entry into an active power state.

In one example, the low power state comprises a sleep power state.

In one example, the configuration data comprises data from configuration registers within the integrated device.

In one example, the configuration registers are to be mapped to a configuration space in memory, and wherein a write to a particular configuration register within the integrated device is to address a memory address within the configuration space in memory to be associated with the particular configuration register.

In one example, An apparatus for device configuration comprising: a first port to couple to a host processing device; a second port to couple downstream to an element, the element to include a configuration register, a cache to hold a configuration value for the configuration register; and a controller capable to associate a memory address with the configuration register and to translate a memory access from the host processing device to the memory address into a configuration request for the configuration register in a first configuration mode, and wherein the controller is further capable to provide the configuration value for the configuration register to the configuration register without the memory access from the host processing device to the memory address in a second configuration mode.

In one example, the first configuration mode comprises an enhanced configuration access mechanism (ECAM) mode and wherein the second configuration mode comprises a fast configuration access mechanism (FCAM) mode.

In one example, the controller is further capable to provide the configuration value for the configuration register to the configuration register without the memory access from the host processing device to the memory address in a second configuration mode comprises the controller to cache the configuration value to be included in the memory access from the host processing device in the cache; provide a completion for the memory access to the host processing device; and provide the configuration value from the cache to the configuration register in the element.

In one example, A method for device configuration comprising: receiving a particular message from a device indicating fast configuration compatibility; updating a configuration register with a reference to a configuration address space for the device in response to receiving the particular message; configuring the device, wherein configuring the device comprises initiating a first memory write to the configuration address space; and initiating a second memory write to a root complex memory space that is to be orthogonal to the configuration address space.

In one example, the particular message comprises a clean base address register message.

In one example, the particular message comprises a device readiness status (DRS) message.

In one example, An apparatus for fast device configuration comprising: configuration logic capable to support write combining and merging to a clean block area comprising one or more clean configuration registers; a port to couple to an upstream device; and protocol logic associated with the port, the protocol logic to generate a particular message to indicate fast configuration capability.

In one example, the particular message comprises a clean base address register message.

In one example, the configuration logic is further to support writes a legacy block,

In one example, the writes to the legacy block are to include read/write byte selects interleaved with data and are to be committed in increasing address order.

In one example, A non-transitory computer readable medium having code, when executed, to cause first device to: receive a particular message to indicate a fast configuration capability of a second device; receive a write message from a third device, the write message to reference an address to be associated with a configuration space of the first device; and initiate a write to the configuration space of the first device; and initiate a completion for the write message to the second device without receiving a response from the first device for the write to the configuration space of the first device.

In one example, the first device in an endpoint device and the second device is a host processing device.

In one example, the first, second, and third devices are included on a single integrated circuit along with storage to hold the code.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1-30. (canceled)

31. An apparatus for device configuration comprising:
interface logic to be coupled to an element;
configuration storage to hold a reference to a configuration context to be associated with the element; and
configuration control logic coupled to the configuration storage and the second interface, the configuration control logic to configure at least part of the configuration context to be associated with the element based on the reference to the configuration context to be held in the configuration storage.

32. The apparatus of claim 31, wherein the interface logic includes physical layer logic based on a physical layer (PHY) specification selected from a group consisting of a low power PHY specification, a mobile industry peripheral interface (MIPI) specification, a peripheral component interconnect express (PCIe) specification, and a higher performance and power PHY specification.

33. The apparatus of claim 31, wherein the element comprises a peripheral component interconnect express (PCIe) device capable of recognizing a plurality of PCIe specification defined protocol communications.

34. The apparatus of claim 31, wherein the configuration context comprises state for a plurality of configuration space parameters for the element.

35. The apparatus of claim 31, wherein the configuration storage to hold a reference to a configuration context comprises an address register to hold an address reference to a memory mapped configuration space to be associated with the element.

36. The apparatus of claim 31, wherein the apparatus comprises a root controller, and wherein the configuration storage comprises cache storage to hold the reference to the configuration context and the configuration context.

37. The apparatus of claim 36, wherein the cache storage is to be coherent with one or more processor caches to be included in a processor to be coupled to the root controller.

38. The apparatus of claim 36, wherein the cache storage is not to be coherent with one or more processor caches to be included in a processor to be coupled to the root controller.

39. The apparatus of claim 36, wherein the cache storage is to implement a write-through policy.

40. The apparatus of claim 31, wherein the configuration control logic to configure at least part of the configuration context is to be in response to a power event.

41. The apparatus of claim 40, the power event comprises an indication that the element is to enter an active power state.

42. The apparatus of claim 40, the power event comprises an indication that the element is to complete link training.

43. The apparatus of claim 31, wherein the interface logic, configuration storage, and configuration control logic are integrated on a system on a chip (SoC) coupled to wireless interface logic capable of voice communication.

44. The apparatus of claim 31, wherein the interface logic, configuration storage, and configuration control logic are integrated on an integrated circuit that is coupled in a non-mobile terminal system.

45. An apparatus for device configuration comprising:
a host processing device;
storage;
an integrated device to write configuration data for the integrated device to the storage and to enter a low power state subsequent to the write of configuration data to the storage; and
a controller coupled to the host processing device, the integrated device, and the storage, the controller to configure the integrated device without direct intervention of the host processing device based at least in part on the configuration data to be held in the storage in response to the integrated device initiating entry into an active power state.

46. The apparatus of claim 45, wherein the low power state comprises a sleep power state.

47. The apparatus of claim 45, wherein the configuration data comprises data from configuration registers within the integrated device.

48. The apparatus of claim 47, wherein the configuration registers are to be mapped to a configuration space in memory, and wherein a write to a particular configuration register within the integrated device is to address a memory address within the configuration space in memory to be associated with the particular configuration register.

49. An apparatus for device configuration comprising:
a first port to couple to a host processing device;
a second port to couple downstream to an element, the element to include a configuration register;
a cache to hold a configuration value for the configuration register; and
a controller capable to associate a memory address with the configuration register and to translate a memory access from the host processing device to the memory address into a configuration request for the configuration register in a first configuration mode, and wherein the controller is further capable to provide the configuration value for the configuration register to the configuration register without the memory access from the host processing device to the memory address in a second configuration mode.

50. The apparatus of claim 49, wherein the first configuration mode comprises an enhanced configuration access mechanism (ECAM) mode and wherein the second configuration mode comprises a fast configuration access mechanism (FCAM) mode.

51. The apparatus of claim 49, wherein the controller is further capable to provide the configuration value for the configuration register to the configuration register without the memory access from the host processing device to the memory address in a second configuration mode comprises the controller to
cache the configuration value to be included in the memory access from the host processing device in the cache;
provide a completion for the memory access to the host processing device; and
provide the configuration value from the cache to the configuration register in the element.

52. A method for device configuration comprising:
receiving a particular message from a device indicating fast configuration compatibility;
updating a configuration register with a reference to a configuration address space for the device in response to receiving the particular message;
configuring the device, wherein configuring the device comprises
initiating a first memory write to the configuration address space; and
initiating a second memory write to a root complex memory space that is to be orthogonal to the configuration address space.

53. The method of claim 52, wherein the particular message comprises a clean base address register message.

54. The method of claim 53, wherein the particular message comprises a device readiness status (DRS) message.

55. An apparatus for fast device configuration comprising:
configuration logic capable to support write combining and merging to a clean block area comprising one or more clean configuration registers;
a port to couple to an upstream device; and
protocol logic associated with the port, the protocol logic to generate a particular message to indicate fast configuration capability.

56. The apparatus of claim 55, wherein the particular message comprises a clean base address register message.

57. The apparatus of claim 55, wherein the configuration logic is further to support writes a legacy block, wherein the writes to the legacy block are to include read/write byte selects interleaved with data and are to be committed in increasing address order.

58. A non-transitory computer readable medium having code, when executed, to cause first device to:
receive a particular message to indicate a fast configuration capability of a second device;
receive a write message from a third device, the write message to reference an address to be associated with a configuration space of the first device; and
initiate a write to the configuration space of the first device; and
initiate a completion for the write message to the second device without receiving a response from the first device for the write to the configuration space of the first device.

59. The computer readable medium of claim 58, wherein the first device in an endpoint device and the second device is a host processing device.

60. The computer readable medium of claim 59, wherein the first, second, and third devices are included on a single integrated circuit along with storage to hold the code.
